(19) United States
(12) Patent Application Publication
(10) Pub. No.: US 2015/0195633 A1
(43) Pub. Date: Jul. 9, 2015

(54) CONFIGURABLE PORTABLE SOUND SYSTEMS WITH INTERCHANGEABLE ENCLOSURES

(71) Applicant: Fugoo Corporation, Irvine, CA (US)

(72) Inventors: Gary Elsasser, Coto de Caza, CA (US); Scott Morford, Dakota Dunes, SD (US)

(21) Appl. No.: 14/586,701

(22) Filed: Dec. 30, 2014

Related U.S. Application Data
(60) Provisional application No. 61/923,670, filed on Jan. 4, 2014.

(51) Int. Cl. H04R 1/02

(52) U.S. Cl. CPC H04R 1/02

(57) ABSTRACT

Embodiments of disclosed portable speakers can be enclosed in interchangeable speaker enclosures (or “jackets”). In some embodiments, jackets can protect a portable speaker from potential damage resulting from moving the speaker, which can be moved around indoors or used outdoors. Jackets can be easily attached to the portable speaker and easily detached from the portable speaker. Jackets can provide aesthetic appeal and protect the speaker from damage, while improving the quality of audio output and enhancing the listening experience.

### CROSS-REFERENCE TO RELATED APPLICATIONS

This application claims the benefit under 35 U.S.C. §119(e) to U.S. Patent Application No. 61/923,670, filed on Jan. 4, 2014, which is incorporated by reference in its entirety.

### BACKGROUND

Loudspeakers produce sound in response to an electrical audio input signal. Loudspeakers are available in different sizes. Large loudspeakers can be used, for example, in theaters, sports venues, and concerts. Small loudspeakers can be used, for example, in consumer electronic devices, such as televisions, laptops, tablets, and cellular phones. Recently, portable loudspeakers have become available. Such portable loudspeakers provide convenience to a listener as they can be moved around indoors or used outdoors. However, small dimensions, limited battery life, and portability of portable loudspeakers pose numerous challenges, such as problems with reproduction of high fidelity sound, protection from potential damage, limited feature sets, and the like. Accordingly, it is desirable to provide portable loudspeakers that address these and other challenges.

### SUMMARY

In some embodiments, a speaker system can include a speaker configured to output audio and a first speaker enclosure that includes a first housing and a first communication interface. The first housing can include an exterior surface and an interior volume, the interior volume dimensioned to hold the speaker when the speaker is placed within the first housing. The first communication interface can be configured to communicate data to the speaker, the data including information that enables the speaker to implement an enclosure profile associated with the first enclosure. In certain embodiments, placing the speaker within the first housing can cause the speaker to output audio in accordance with a first audio output profile of a plurality of audio output profiles, the first audio output profile corresponding to the enclosure profile that is associated with the first enclosure and that is communicated to the speaker over the first communication interface.

The speaker system of the preceding paragraph may also include any combination of the following features described in this paragraph, among others described herein. In some embodiments, the speaker is compatible with a second speaker enclosure that includes a second housing. Placing the speaker within the second housing of the second speaker enclosure causes the speaker to output audio in accordance with a second audio output profile of the plurality of audio output profiles, the second audio output profile different from the first audio output profile, and the second audio output profile corresponding to an enclosure profile that is associated with the second enclosure and that is communicated to the speaker over a second communication interface.

The speaker system of the preceding paragraphs may also include any combination of the following features described in this paragraph, among others described herein. In certain embodiments, the speaker can be portable. In some embodiments, the first and/or second speaker enclosure includes input and output interfaces on the exterior surface of the first and/or second housing. The input interface can be configured to receive input data configured to be communicated to the speaker and cause the speaker to adjust one or more audio playback parameters. The output interface can be configured to provide output data in addition to audio output by the speaker. In various embodiments, the input data includes at least one of power and audio volume. In some embodiments, the output interface includes one or more light sources, which can be configured to illuminate the first and/or second housing. In certain embodiments, output data can comprise time information and the one or more light sources are configured to output the time information. In some embodiments, output data includes audio playlist information. The input and output interfaces can be combined together in a touch screen display such as a liquid crystal display (LCD) according to some embodiments.

The speaker system of the preceding paragraphs may also include any combination of the following features described in this paragraph, among others described herein. In various embodiments, the speaker system (for example, the speaker enclosure) includes a memory device configured to store the enclosure profile. The enclosure profile can include information related to acoustic properties of the enclosure. The acoustic properties of the enclosure can be based at least in part on one or more of dimensions of the enclosure and composition of materials of the housing. In some embodiments, the first audio output profile can include one or more audio signal processing settings. In certain embodiments, the speaker system can include a voice detection module configured to receive and process voice commands from a listener or user, the voice commands configured to operate the speaker.

The speaker system of the preceding paragraphs may also include any combination of the following features described in this paragraph, among others described herein. In various embodiments, the speaker system includes a user actuatable control positioned on the exterior surface of the first and/or second housing. Actuation of the control can cause the speaker to change at least one audio output parameter. Actuatable control can include a fastener configured to maintain positioning of the speaker within the first and/or second housing. The fastener can be configured to be moved between open and closed positions and moving the fastener between the open and closed positions can cause the speaker to change the at least one audio output parameter. The at least one audio output parameter can be audio volume. In some embodiments, moving the fastener from the open position to the closed position can cause the audio volume to increase. In certain embodiments, the communication interface of the speaker system includes a wireless interface. In various embodiments, the first and/or second housing of the speaker system includes an attachment module configured to be attached to a mounting system, which can be configured to be mounted to a structure.

In some embodiments, an enclosure for a portable speaker includes a housing having an exterior surface and an interior volume. The interior volume can be dimensioned to hold the speaker when the speaker is placed within the housing. The enclosure can also include a communication interface configured to communicate with a speaker configured to be placed within the housing. Placing the speaker within the housing can cause the speaker to select an audio output profile from a plurality of audio output profiles and output audio in accordance with the selected audio output profile, the selected audio output profile corresponding to an enclosure profile associated with the enclosure. The communication interface can be configured to communicate data to the speaker that is sufficient to enable the speaker to identify audio processing for use when the speaker is attached to the enclosure and within the housing. In certain embodiments, the enclosure includes a power source configured to power the speaker placed within the housing.

In various embodiments, a method of reproducing audio using a portable speaker includes communicating an enclosure profile to the speaker enclosed in a speaker enclosure. This or some other trigger, such as detection by the speaker of attachment of the speaker enclosure to the speaker, can cause the speaker to select a corresponding audio output profile from a plurality of audio output profiles and output audio in accordance with the selected audio output profile. The method can be performed by the speaker enclosure having a housing configured to at least partially enclose the speaker when the speaker is placed within the housing.

The method of the preceding paragraph may also include any combination of the following features described in this paragraph, among others described herein. In some embodiments, the method can further include receiving (for example, from a user) input data configured to change at least one audio output parameter of the speaker and communicating the input data to the speaker, thereby causing the speaker to change the at least one audio output parameter. The method can also include outputting data to the user in addition to audio produced by the speaker.

In some additional embodiments, a portable speaker system can include a portable speaker. The portable speaker can include a portable housing and one or more loudspeakers supported by the portable housing. The portable speaker can further include an audio processor within the portable housing and configured to process a source audio signal to generate a processed audio signal. Audio electronics within the portable housing can be configured to receive the processed audio signal and to drive the loudspeakers to output audio based on the processed audio signal. The portable speaker can further include a rechargeable battery. The portable speaker system also includes a first speaker enclosure configured to releasably retain the speaker. The first speaker enclosure includes a first housing comprising an exterior surface and an interior volume, where the interior volume dimensioned to receive the portable speaker. The first speaker enclosure can include a first communication interface configured to communicate data to the portable speaker, where the data includes first information that enables the speaker to identify an audio output profile associated with the first enclosure. The audio processor of the portable speaker can be further configured, based at least in part on the first information, to process the source audio signal in accordance with a first audio output profile associated with the first enclosure.

The portable speaker system of the preceding paragraph may also include any combination of the following features described in this paragraph, among others described herein. In some embodiments, the portable speaker system is compatible with a second speaker enclosure configured to releasably retain the portable speaker. The second speaker enclosure can include a second housing comprising an exterior surface and an interior volume, where the interior volume is dimensioned to receive the portable speaker. The second speaker enclosure can further include a second communication interface configured to communicate data to the speaker, where the data includes second information that enables the speaker to identify an audio output profile associated with the second enclosure. The audio processor can be further configured, based at least in part on the second information, to process the source audio signal in accordance with a second audio output profile associated with the second enclosure, where the second audio output profile different from the first audio output profile.

The portable speaker system of the preceding paragraphs may also include any combination of the following features described in this paragraph, among others described herein. The first enclosure can further include an input interface on the exterior surface of the first housing, where the input interface is configured to receive user input data. The user input data can be communicated to the speaker via the first communication interface, causing adjustment of one or more audio playback parameters by the portable speaker. The input data can include volume adjustment information.

The portable speaker system of the preceding paragraphs may also include any combination of the following features described in this paragraph, among others described herein. The first enclosure can further include one or more light sources configured to illuminate the first housing. The first enclosure further comprises an electronic display on the exterior surface of the first housing. The electronic display can be updated based on information electronically received by the first speaker enclosure from the speaker when the speaker is releasably retained within the first enclosure. The electronic display can be configured to display a clock. The electronic display can be configured to display one or more of artist, song title, or playlist information.

The portable speaker system of the preceding paragraphs may also include any combination of the following features described in this paragraph, among others described herein. The first speaker enclosure can further include a memory device configured to store the first information. The first audio output profile can cause the audio processor to process the source audio signal in accordance with acoustic properties of the first enclosure. The acoustic properties of the first enclosure may be related to one or more of physical dimensions of the enclosure and composition of materials of the first housing. The first audio output profile can include one or more audio signal processing settings.

According to additional aspects, a method of reproducing audio using a portable speaker is provided. The method can include communicating an enclosure profile to a speaker enclosed in a speaker enclosure. This or some other trigger, such as detection by the speaker of attachment of the speaker enclosure to the speaker, can cause the speaker to, based at least in part on the enclosure profile, select a corresponding audio output profile from a plurality of audio output profiles. The speaker may then output audio in accordance with the selected audio output profile.

The method of the preceding paragraph may also include any combination of the following features described in this paragraph, among others described herein. In some embodiments, the method includes receiving input data entered via an interface provided on the speaker enclosure and configured to change at least one audio output parameter of the speaker. The method can further include communicating the input data from the enclosure to the speaker, thereby causing the speaker to change the at least one audio output parameter. The method can further include outputting, via an interface provided on the enclosure, data provided to the enclosure from the speaker. The data can be output in addition to audio produced by the speaker.

According to some further aspects, a portable speaker system includes a portable speaker and a speaker enclosure. The speaker includes a portable housing and one or more loudspeakers supported by the housing. The speaker can further include an audio processor configured to process a source audio signal to generate a processed audio signal. The speaker can further include a rechargeable battery. The speaker enclosure is configured to releasably retain the speaker, and can include a body comprising an exterior surface and an interior volume, where the interior volume dimensioned to receive the speaker. In some embodiments, the enclosure further includes a communication interface configured to allow electronic communication between the speaker and the speaker enclosure. The enclosure also includes a display configured to display graphical information based on data received via the communication interface. The graphical information can include time information.

### DESCRIPTION OF THE DRAWINGS

FIG. 1 illustrates speakers enclosed in speaker enclosures according to some embodiments.

FIGS. 2A-2B illustrate communication systems according to some embodiments.

FIGS. 3A-3B illustrate placement of a speaker in a speaker enclosure according to some embodiments.

FIG. 4 illustrates a speaker enclosure according to some embodiments.

FIGS. 5A-5D illustrate placement of a speaker in a speaker enclosure according to some embodiments.

FIG. 6 illustrates a speaker enclosure according to some embodiments.

FIG. 7 illustrates placement of a speaker in a speaker enclosure according to some embodiments.

FIG. 8 illustrates a speaker enclosure according to some embodiments.

FIG. 9 illustrates a speaker enclosure according to some embodiments.

FIG. 10 illustrates attachment of a speaker enclosed in a speaker enclosure to an accessory according to some embodiments.

FIGS. 11A-11B illustrate a speaker according to some embodiments.

FIG. 12 illustrates a speaker according to some embodiments.

### DETAILED DESCRIPTION

### Overview

Generally described, the present disclosure is directed to configurable portable sound systems with interchangeable enclosures (or “jackets”). Although various aspects of the disclosure will be described with regard to examples and embodiments, one skilled in the art will appreciate that the disclosed embodiments and examples should not be construed as limiting.

Embodiments of disclosed portable speakers provide convenience to a listener as they can be moved around indoors or used outdoors. In some embodiments, portable speakers can be small and lightweight. Portable speakers can communicate with one or more audio devices over wired or wireless connections, such as Bluetooth, Wi-Fi, Wireless Speaker and Audio (WiSA), and the like. Disclosed portable speaker embodiments can output or reproduce high quality and fidelity stereo audio, while maintaining low energy consumption. For example, a portable speaker can be capable of continuous playback of 10 or more hours.

### Speaker Jackets

Embodiments of disclosed portable speakers can be enclosed in interchangeable speaker enclosures or jackets. In some embodiments, jackets can protect a portable speaker from potential damage resulting from moving the speaker, which can be used indoors or outdoors. In some embodiments, jackets can be easily attached to the portable speaker and easily detached from the portable speaker. Jackets can provide aesthetic appeal and protect the speaker from damage, while improving the quality of audio output and enhancing the listening experience. Moreover, in accordance with embodiments described herein, interchangeable jackets are described having a wide variety of different feature sets including different display configurations, audio enhancement functionality, user inputs, etc., providing a high degree of flexibility, customization, and upgrade capability.

In some embodiments, a jacket can communicate with a speaker enclosed in the jacket. The speaker can select an enclosure profile based on data communicated by the jacket to the speaker. The enclosure profile can include various parameters, such as information related to acoustic properties of the jacket, listening environment where the speaker is expected to be used, listener preferences, and the like. The speaker can adjust or vary audio output based on the selected enclosure profile. For example, the speaker can adjust one or more audio playback parameters based on the acoustic properties of the jacket, such as the dimensions of the jacket, composition of materials of the jacket, etc. As another example, the speaker can adjust one or more audio playback parameters based on the listening environment, such as increase the intensity of playback when the speaker is used outdoors, boost low frequencies (or base) when the speaker is used indoors, and the like.

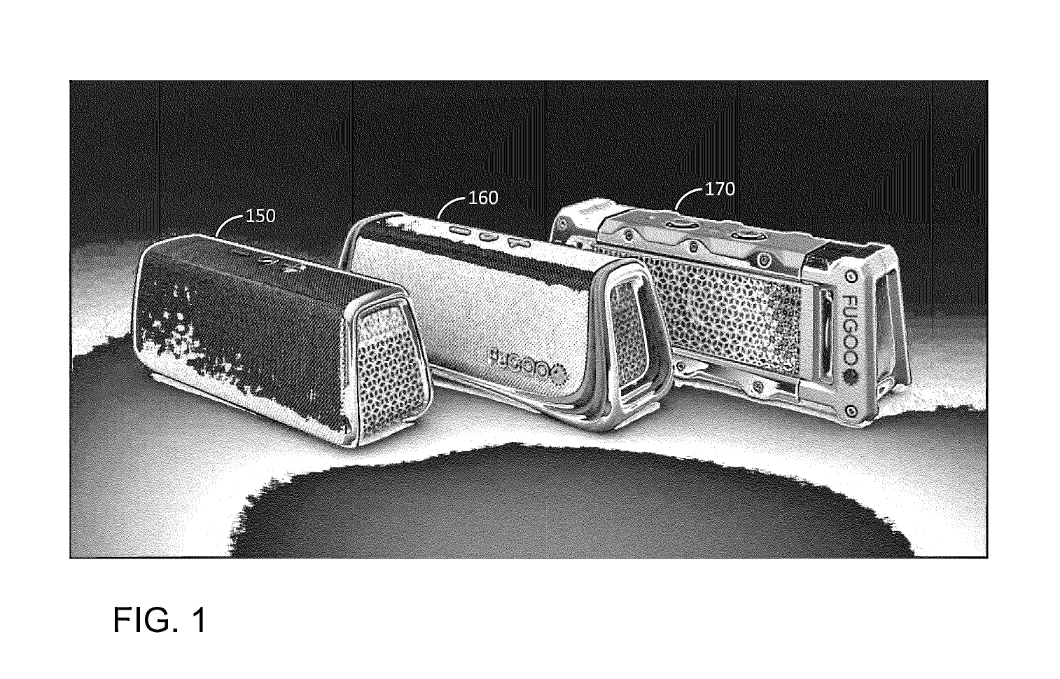

FIG. 1 illustrates combinations 150, 160, and 170 of speakers enclosed in speaker enclosures or jackets according to some embodiments. The illustrated jackets can be configured to enclose or partially enclose a speaker. The jackets can be configured to substantially match or correspond to the dimensions and shape of the speaker. The illustrated jackets can be made out of materials and can have properties suitable for environment and/or conditions under which the speaker is used. For example, the jacket in combination 160 can be configured for outdoor use and, thereby, can be fully or partly made of waterproof material and have one or more holes or grooves for draining water. As another example, the jacket in combination 170 can also be configured to outdoor use, but can be sturdier than the jacket in combination 160.

Each of the jackets can be configured to attach to and operate with a common speaker type, where users can swap out different jackets for use with the speaker as desired. For instance, in some embodiments, the speaker can detect the type of jacket that is currently attached to the speaker and be configured to select a suitable enclosure profile depending on the jacket type. The speaker can select an enclosure profile based on data communicated by the jacket to the speaker, over a wired or wireless connection between the speaker and jacket or other suitable interface. The suitable enclosure profile can specify various parameters, such as information related to acoustic properties of the jacket and/or corresponding audio processing information, listening environment where the speaker is expected to be used, listener preferences, and the like.

The speaker can adjust or vary audio output based on the selected enclosure profile. For example, the speaker can adjust one or more audio playback parameters (such as intensity at selected or all frequencies) based on the acoustic properties of the jacket, such as the dimensions of the jacket, composition of materials of the jacket, etc. As another example, the speaker can adjust one or more audio playback parameters based on the listening environment, such as increase the intensity of playback when the speaker is used outdoors, boost low frequencies (or base) when the speaker is used indoors, and the like.

The speaker can also provide information to be output to the user via the enclosure profile. The provided information can include volume control, clock, alarm clock, audio playlist, and the like. The jacket can output the provided information in any suitable way, including visually (for example, via a display), and the like.

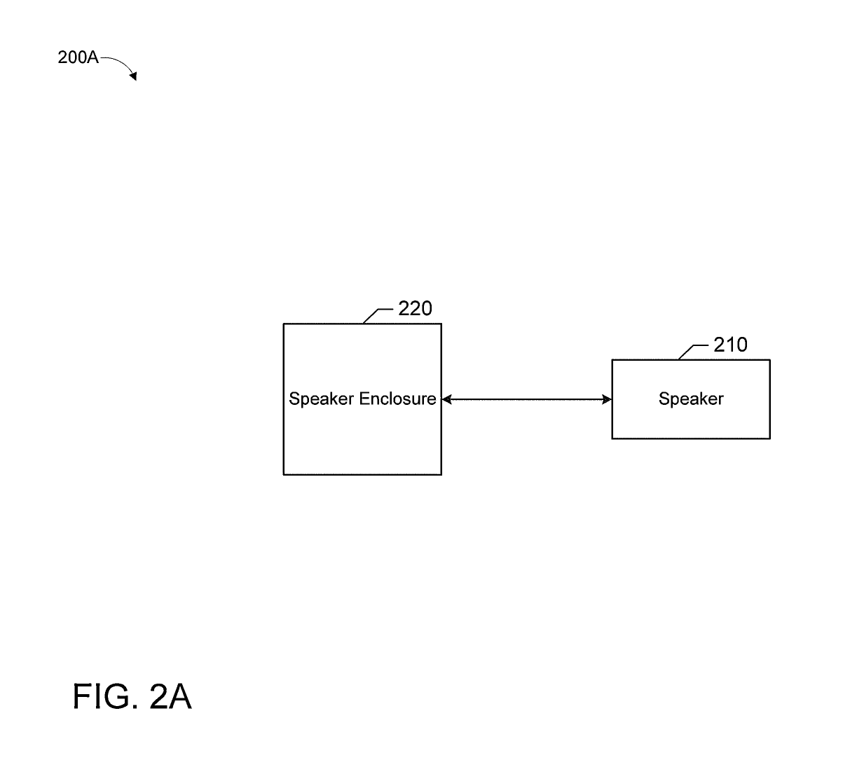

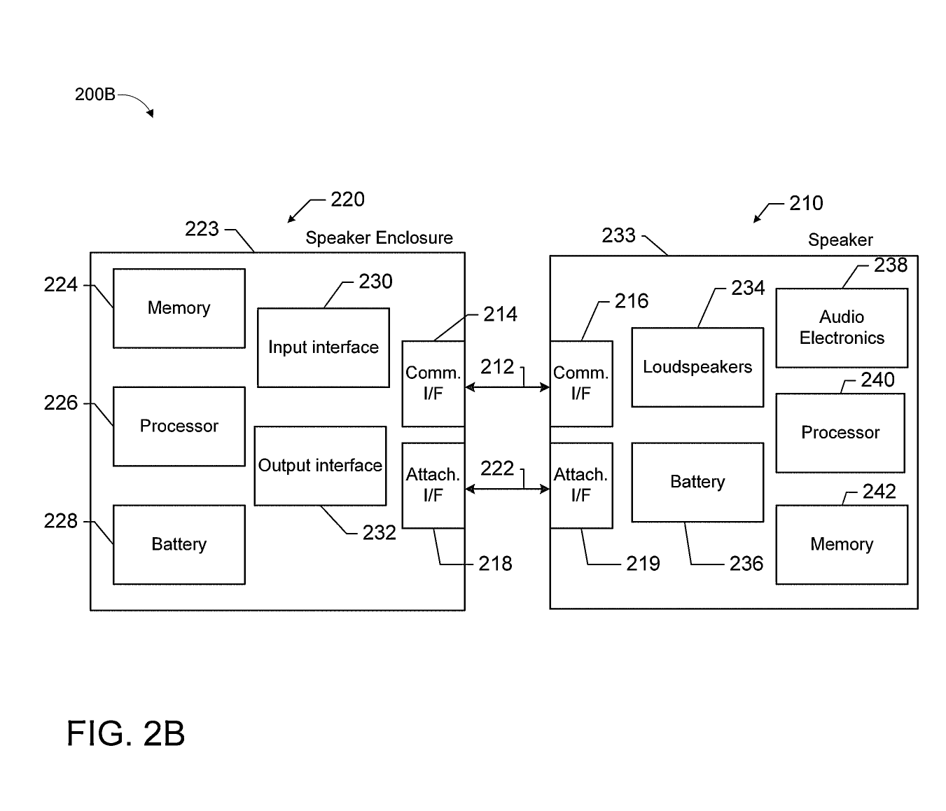

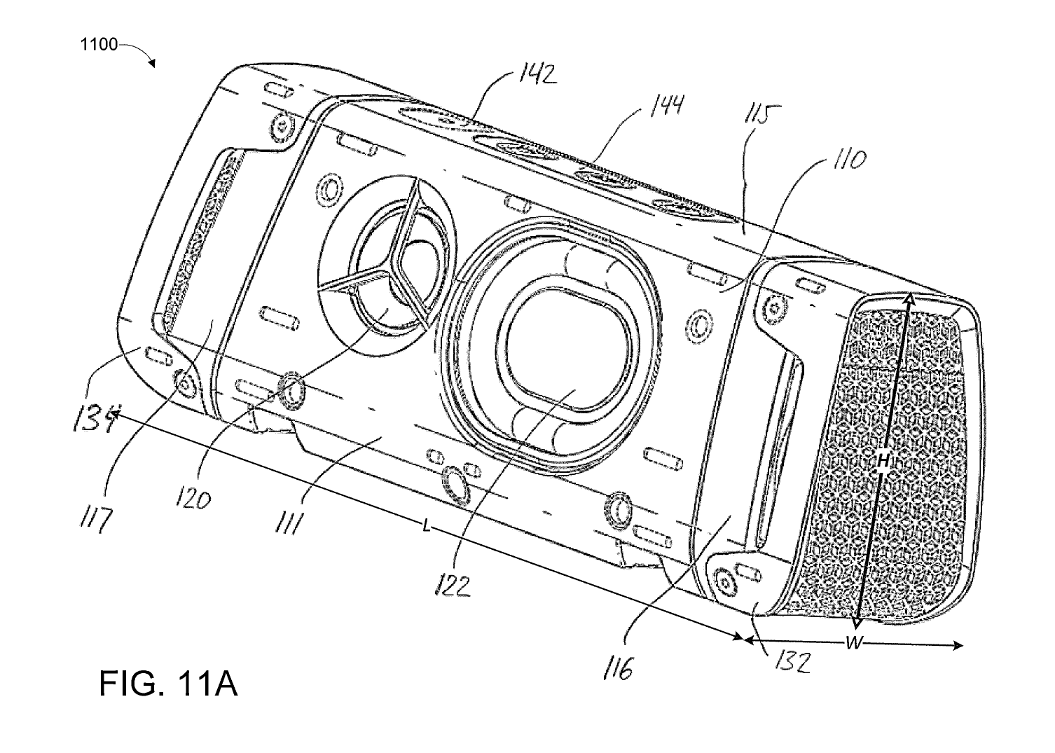

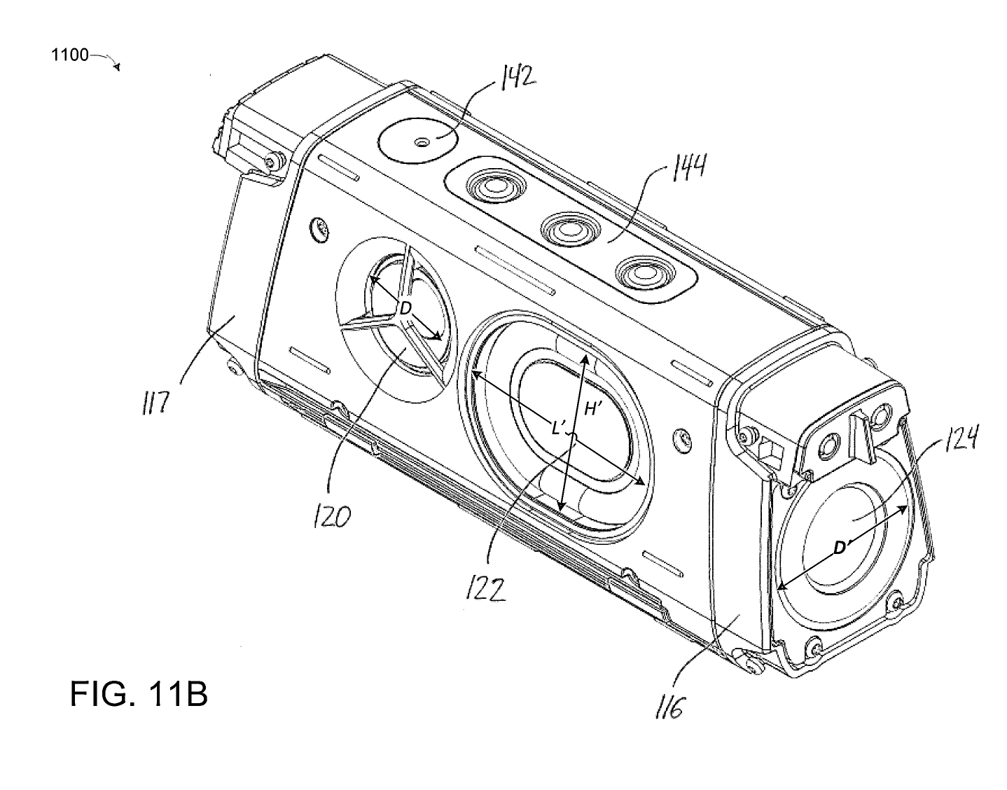

FIG. 2A illustrates a communication system 200A according to some embodiments. As is illustrated, a speaker 210 (e.g., speaker 1100 illustrated in FIG. 11A) communicates with a speaker enclosure or jacket 220. The jacket 220 can be any one of the disclosed jackets, or some other jacket. The communication can be a two-way communication, in which the speaker 210 sends data to the jacket 220 and receives data from the jacket 220. Communication (or channel) between the speaker 210 and the jacked 220 can be wired or wireless. In some embodiments, communication can be performed using Bluetooth. In some embodiments, communication can be configured for one-way communication in which the speaker 210 sends data to the jacket 220 without the jacket 220 sending data to the speaker 210 or vice versa.

FIG. 2B illustrates a communication system 200B according to some embodiments includes a combination of a speaker 210 and a speaker enclosure or jacket 220. As is illustrated, the speaker 210 communicates with the jacket 220 via a wired or wireless connection 212 between a communication interface 214 of the jacket 220 and a corresponding communication interface 216 of the speaker 210. The jacket 220 is configured for removable attachment to the speaker 220 via a mechanical connection 222 between an attachment interface 218 of the jacket 220 and a corresponding attachment interface 219 provided on the speaker 210.

The jacket 220 includes a body 223 which, depending on the embodiment, supports one or more of one or more of a memory 224, a processor 226, a battery 228, an input interface 230, and output interface 232.

The body 223 of the jacket 220 can be formed from a structure defining an interior cavity or region shaped to accommodate the speaker 210. The body 223 can include a rigid or semi-rigid frame formed from plastic, rubber, metal, or combinations of the same or the like. Depending on the type of jacket, additional material can be attached to or supported by the frame of the body 240 to provide acoustic and/or aesthetic functionality, such as fabric or mesh material.

Where the jacket 220 includes a memory 224, the memory 224 can be a flash memory or other appropriate type of electronic storage device, and can be configured to store audio profile information or any of the other types of information to support the various functionalities associated with the jacket 220 described herein. In one embodiment, the memory 224 is a memory card that is releasably retained in a memory card slot of the body 223.

The processor 226 can include one or more of any type of appropriate microprocessor, controller, microcontroller, digital signal processor (DSP), etc. The processor 226 can be programmed to support any of the functionality associated with the jacket 220. For instance, the processor 226 can be in communication with the memory 224 and can also be programmed to communicate with, control or otherwise enable operation of one or more of the communication interface 214, input interface 230, and output interface 232.

The battery 228 can be any type of appropriate battery or other power source, such as a rechargeable battery. The battery 228 can act as a power source for components of the jacket 223, and in some embodiments can act as a supplemental power source to power the speaker 210 when the jacket 220 is attached to the speaker 210. In some embodiments, the jacket 220 is powered by the speaker 210 and does not does not include a battery 228.

The communication interface 214 can be configured to communicate with the corresponding communication interface 216 of the speaker 210. The communication interface 214 of the jacket 220 and corresponding communication interface 216 of the speaker 220 can support either one-way communication from the jacket 220 to the speaker 210 or vice versa, or two-way communication. The communication interfaces 214, 216 can include electrical contacts that come into physical contact with one another when the jacket 220 is attached to the speaker 210, thereby establishing an electrical connection between the jacket 220 and the speaker 210. In other embodiments, the communication interfaces 214, 216 support a wireless connection between the jacket 220 and the speaker 210. As will be appreciated, the interfaces 214, 216 can incorporate any appropriate type of contacts, wires, or other appropriate physical componentry, and/or any appropriate electronics, software and/or firmware configured to allow communication between the jacket 220 and the speaker 210.

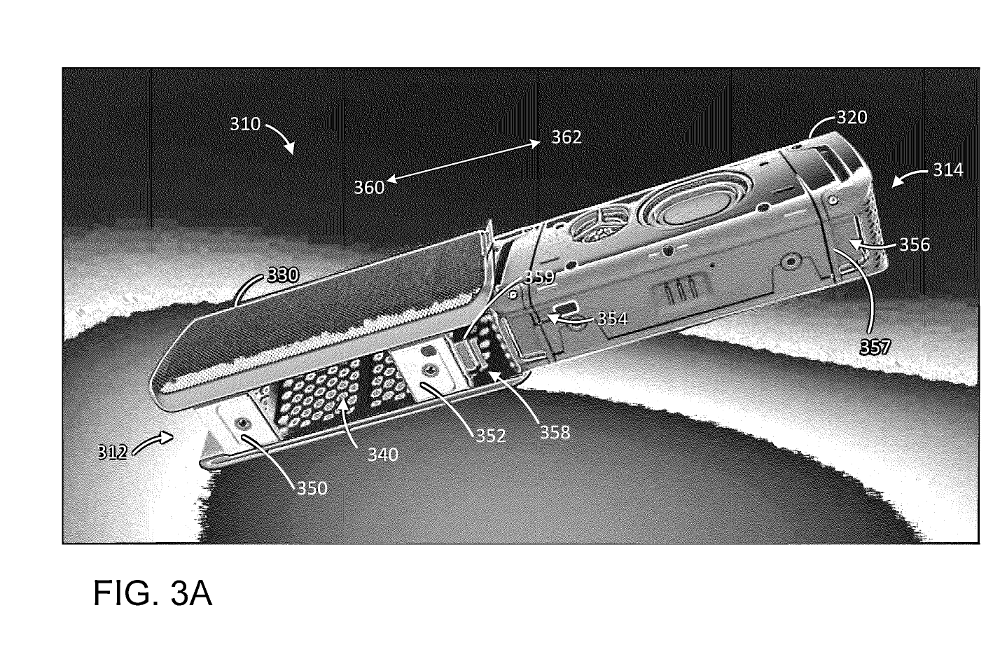

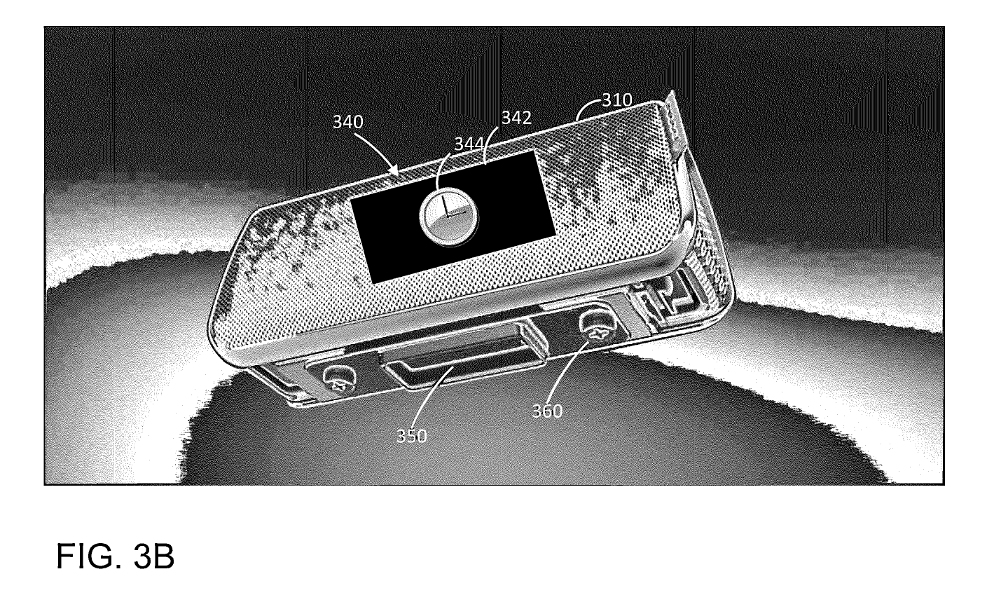

The attachment interface 218 of the jacket 210 is configured to interact with the corresponding attachment interface 219 provided on the speaker 220. For instance, the attachment interfaces 218, 219 can include complementary mechanical features that operate to secure the jacket 220 to the speaker 210 via interlocking, friction fit, or otherwise, as is described elsewhere herein, such as with respect to FIGS. 3A-10, and such as are also described in U.S. Provisional Patent Application Nos. 61/923,554, titled “SPEAKER SYSTEM”, filed Jan. 3, 2014 (Atty. Docket No. FUG00.010PR), which is incorporated by reference herein in its entirety.

The input interface 230 can generally include one or more controls, menus, or other interfaces that allow users to control the system 200B when the jacket 220 is attached to the speaker 210. Some illustrative examples of different input interfaces will now be described.

The input interface 230 can be configured to allow a listener to provide input commands or other data to the speaker 210. The input interface 230 can communicate received input data to the speaker 210 using the communication interface 214. Input data can include listener preferences, such as for example, audio volume setting.

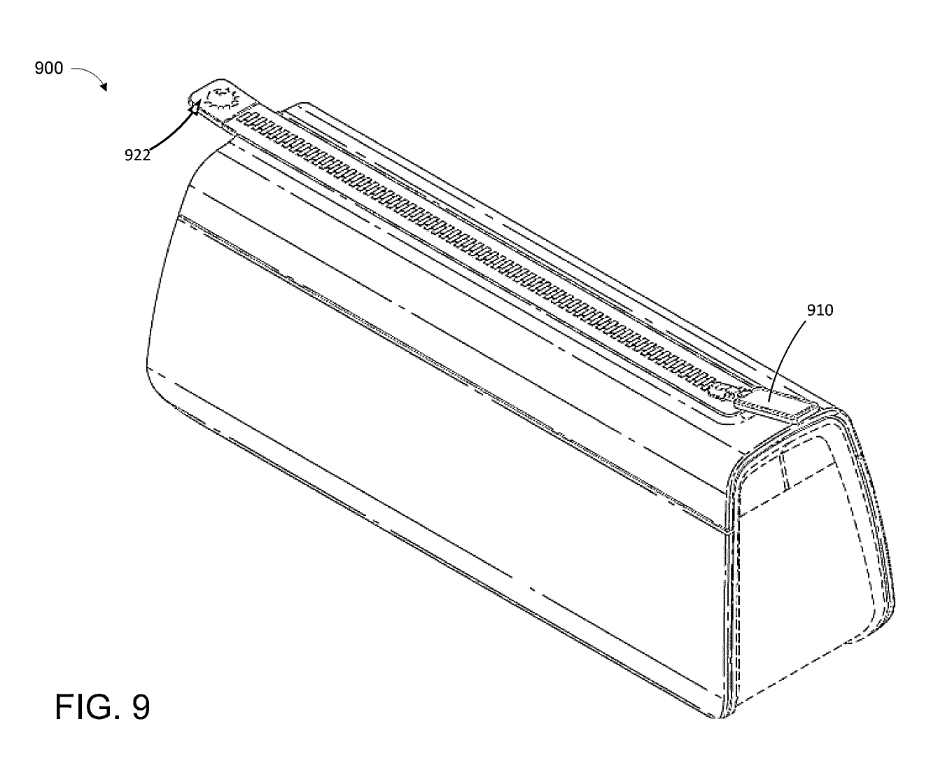

The input interface 230 can include one or more listener controls provided on an exterior surface of the body 223 of the jacket 220. The listener controls can be buttons, knobs, switches, touch screen interfaces, voice commands, and the like, and can allow users to control operation of the speaker 210. For instance, the controls can include volume controls, audio input source selections, audio playback controls (“play”, “pause”, “stop”, “fast forward”, etc.), and the like. In various embodiments, as is illustrated in FIG. 9, a fastener or zipper can be configured as a listener control (for example, volume control). While shown as a single interface, the input interface 230 may comprise a combination of a plurality of separate interfaces provided on the jacket 210. For instance, the input interface 230 may include one or more touch display screens, one or physical buttons, or a combination of display screen(s) and button(s).

The input interface 230 can include one or more override controls configured to allow the listener to override one or more default or programmed behaviors of the speaker 210 and the jacket 220. As one example, an enclosure is configured for outdoor use, and the speaker 210 is responsive to attachment of the jacket 220 to automatically implement one or more enclosure profiles and corresponding audio output profiles that enhance intensity of audio playback (e.g., volume). The input interface 230 of the jacket 220 provides an override control allowing a listener to override the default behavior. For instance, the override control can allow the listener to select a different audio processing profile, such as one designed for an indoor environment, or one designed to provide some other type of acoustic characteristics.

In certain embodiments, the input interface 230 can comprise a voice detection module configured to receive and process listener voice commands.

The input interface 230 can supplement or replace one or more controls provided on the speaker 210. For instance, the speaker 210 can include can buttons or other inputs for controlling power, volume, Bluetooth pairing or other wireless pairing to smartphones or other electronic devices, etc., and the input interface 230 of the jacket 220 can provide corresponding controls that replace or supplement the controls on the speaker 210. In one illustrative example, the speaker 210 includes physical control buttons for adjusting volume and pausing/restarting playback, and the input interface 230 includes a touch display screen allowing users to adjust the volume and pause/restart playback, instead of or as alternative to the control buttons.

In various embodiments, the output interface 232 of the jacket 320 can be configured to output to the listener data that is separate from audio played back by the speaker 210. The output interface 232 can include one or more components that provide information visually, audibly, and the like. For instance, the output interface 232 can include one or more light sources (e.g., LEDs), clocks, alarm clocks, displays, speakers, and the like, which can be placed or positioned on the exterior surface of the jacket 220.

For example, the one or more light sources of the output interface 232 can be configured to illuminate the jacket, such as to provide ambient lighting for the jacket 220. For instance, the light sources can be configured to illuminate with different colors (e.g., using a set of differently colored LEDs) or at different intensities. A listener can select a desired ambient lighting profile via the input interface 230 in one embodiment. In one implementation, a set of ambient lighting profiles are stored in the jacket memory 224 and downloaded to the speaker 210. The lighting profile can be stored as part of the jacket's enclosure profile in the speaker 210.

As indicated, the output interface 232 can include one or more displays, which can be configured to display one or more audio playback parameters or settings to the listener. For example, one or more displays can be configured to provide name and artist of the song being played back, volume level, battery level, and the like. A clock and alarm clock can be provided on the exterior of the jacket 220. In some embodiments, the display(s) of the output interface 232 are user configurable. For instance, a user may be able to select from between a “clock mode”, where the display presents a clock and can provide alarm clock functionality, and an audio mode where the display presents audio information (e.g., artist/title information, volume level, etc.). A user may be able to customize the display using a separate interface, such as a software interface running on a separate computer, for download to the jacket 220.

The speaker 210 can output voice prompts or notifications (e.g., “powering on”, “powering off”, “pairing mode”, “battery full”, “battery half full”, “battery almost empty”, “recharge battery”, “loud mode”, etc.) via the loudspeakers 234. Recordings of these voice prompts/notifications can be stored in the memory 242 in a voice package. In some cases, more than one voice package can be stored in the memory 242, such as where each voice package corresponds to a different person's voice, and the user can select from between a default voice package and an alternative voice package or packages. The jacket 220 in some embodiments can store or otherwise be associated with one or more additional voice packages for use when the jacket 220 is attached to the speaker 210. For instance, in one embodiment, the jacket 220 stores an alternate voice package in the memory 224, and the speaker 210 is configured to automatically download and begin using the alternate voice package when the jacket 220 is attached to the speaker 210. In another implementation, the speaker 210 begins using the alternative voice package in response to a user command. In further embodiments, alternate voice packages corresponding to one or more of different jacket types are pre-loaded in the memory 242 of the speaker 210, along with associations of the different alternate voice packages to each corresponding jacket type. When a particular type of jacket is attached to the speaker 210, the speaker 210 is configured to detect the type of attached jacket, determine the appropriate alternate voice package corresponding to the attached jacket, and swap out the current voice package for the identified alternate voice package corresponding to the appropriate jacket.

In some embodiments, enclosure profiles can be configured to store listener's preferences, such as audio playback preferences, ambient lighting preferences, time settings, alarm clock settings, voice control, voice package preferences, and the like.

In some embodiments, the jacket 220 can include additional components, memory modules, interface modules, sensors, or transducers. For example, the jacket 220 can include an interface module configured to allow the listener to configure the jacket 220 or the speaker 210 via an electronic device, such as a smartphone. The interface module can be a wired or wired interface, such as Bluetooth interface, IrDa (infrared) interface, Wi-Fi interface, USB interface, and the like. As another example, the jacket 220 can include one or more sensors configured to detect properties of the environment, such as indoors or outdoors, where the speaker and the jacket are being used. Such sensor can include light sensors (e.g., to detect sunlight), moisture sensors, humidity sensors, wind sensors, and the like. In generally, a wide variety of different implementations for the jacket 220 are possible, and one or more of components illustrated in FIG. 2B can be omitted, depending on the particular embodiment.

As shown, the speaker 210 includes a housing 233 containing or otherwise supporting one more of a set of one or more loudspeakers 234, a battery 236, audio electronics 238, a processor 240, and a memory 242.

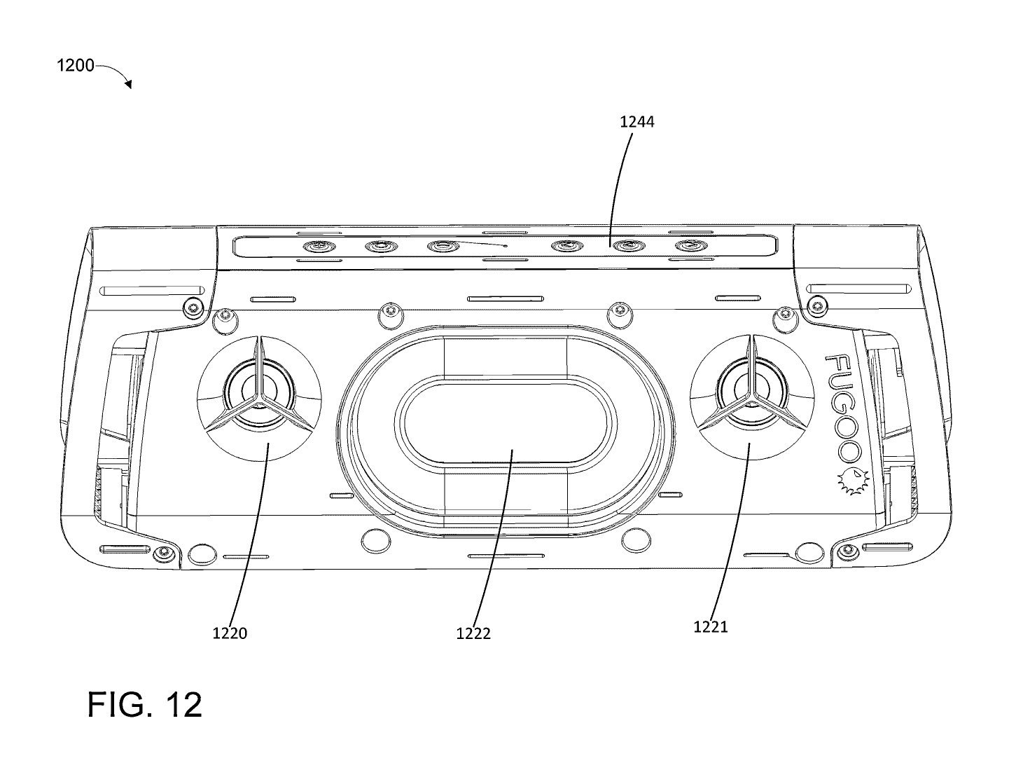

The housing 233 can be made of any appropriate material including plastic, rubber, metal, or combinations thereof. The loudspeakers 234 can include an appropriate combination of speakers including one or more tweeters, woofers, sub-woofers, passive radiators, etc., supported by the housing 233. Examples of compatible speakers and corresponding housings 233 and arrangements of loudspeakers 234 are shown and described throughout, such as with respect to FIGS. 11A, 11B, and 12. Additional examples of compatible speakers and enclosures/jackets are provided in U.S. Patent Application No. 61/923,575, titled “PORTABLE STEREO SOUND SYSTEM”, filed Jan. 3, 2014 (Atty. Docket No. FUG00.009PR), and U.S. Patent Application No. 61/923,554, titled “SPEAKER SYSTEM” (Atty. Docket No. FUG00.010PR), filed Jan. 3, 2014, each of which is incorporated by reference in its entirety herein.

The processor 240 can include one or more of any type of appropriate microprocessor, controller, microcontroller, digital signal processor (DSP), etc. The processor 240 can be programmed to support any of the functionality associated with the jacket 220 and/or speaker 210 described herein. For instance, the processor 226 can be in communication with the memory 242 and can also be programmed to communicate with, control or otherwise enable operation of one or more of the communication interface 216, loudspeakers 234, and audio electronics 238 of the speaker 210. The processor 240 can also be configured when the jacket 220 is attached to the speaker 210 to communicate with, control or otherwise enable operation of one or more components of the jacket 220 such as the input interface 230, output interface 232, and communication interface 214.

The memory 242 be a flash memory or other appropriate type of electronic storage device, and can be configured to store audio profile information, audio processing software or firmware executable by the processor 226, or any of the other types of information to support the various functionalities associated with operation of the jacket 220 and/or speaker 210 described herein.

The battery 236 can be any type of appropriate battery or other power source, such as a rechargeable battery. The battery 236 can act as a power source for components of the speaker 210 and can also act as a power source for components in the jacket 220 when the jacket 220 is attached to the speaker 210.

In certain embodiments, the speaker 210 can be configured to implement a plurality of enclosure profiles (also referred to as “jacket profiles”). For example, the speaker 210 can implement a particular enclosure profile for each particular type of jacket. Enclosure profiles can be stored in the memory 242 of the speaker 210 and/or the memory 224 of the jacket 220.

Each enclosure profile can include information regarding one or more audio output processing profiles or other parameters, and or output interface parameters. For example, an enclosure profile corresponding to a jacket that is desired for indoor use and expected to typically be used with the speaker 210 during indoor use (e.g., jacket in combination 150 of FIG. 1) can include information, such as non-linear equalization profile, directing the speaker 210 to enhance bass output at lower sound intensity levels (e.g., lower volume settings). As another example, the non-linear equalization profile can direct the speaker 210 to enhance bass output while lowering sound intensity. As the sound intensity level is increased, the amplification of bass components can be reduced in order to provide greater sound intensity. As yet another example, an enclosure profile corresponding to a jacket that is expected to be used with the speaker 210 during outdoor use (e.g., jacket 160 or 170) can include information, such as non-linear equalization profile, directing the speaker 210 to enhance sound intensity levels (e.g., playback volume), while lowering the intensity of bass output. In certain embodiments, quality of bass playback can be sacrificed in order to increase audio playback intensity (e.g., volume).

In some embodiments, one or more enclosure profiles can direct the speaker to alter or modify one or more audio playback parameters in one or more frequency ranges, such as low frequencies, mid frequencies, and high frequencies. The one or more enclosure profiles can take into account the acoustic properties of a corresponding enclosure, such as the dimensions of the enclosure, shape of the enclosure, materials making up the enclosure, thickness of the enclosure, and the like. For example, for a particular enclosure that is made out of thick material (e.g., felt) that can absorb audio at lower frequencies, a corresponding enclosure profile can direct the speaker 210 to enhance audio playback at lower frequencies. As another example, for a particular enclosure geometry that may produce standing waves at one or more audio frequency ranges, a corresponding enclosure profile can direct the speaker 210 to decrease or mute audio playback intensity at such one or more frequency ranges.

In certain embodiments, the communication interface 240 can be configured to communicate to the speaker 210 information or data sufficient for the speaker to implement an enclosure profile associated with the enclosure. For example, each jacket 220 can store in memory a particular unique identifier corresponding to the type of the jacket, and this identifier can be communicated to the speaker 210. This information can be communicated to the speaker 210 once the communication interfaces 214, 216 establish the connection 212 with one another, such as when the jacket 220 is attached to the speaker 210 via the connection 222 using the attachment interfaces 218, 219. Using the information communicated by the jacket 220, the speaker 210 can select from a plurality of enclosure profiles an enclosure profile corresponding to the jacket and implement or execute the selected enclosure profile.

In various embodiments, when the speaker 210 is removed from a first jacket and placed into a second jacket, the communication interface 214 of the second jacket can communicate to the speaker 210 information identifying the second jacket. Based on this information, the speaker 210 can select and implement an enclosure profile corresponding to the second jacket. The speaker 210 can cease or stop implementing the enclosure profile corresponding to the first jacket upon removal of the speaker from the first jacket.

In other implementations, the enclosure profile is stored in the memory 224 of the jacket 220, and the profile is communicated via the connection 212 to the speaker 210, either for real-time processing by the processor 240 of the speaker 210, or for storage in the memory 242 of the speaker 210 for later access by the processor 240 of the speaker 210.

The embodiments described with respect to the jacket 220 and speaker 210 of FIGS. 2A-2B are compatible with any of the other jackets and speakers provided herein in association with the other drawings.

FIG. 3A illustrates a combination 310 of a speaker 320 and a speaker jacket or enclosure 330 according to some embodiments. As is illustrated, the combination 310 includes a forward end 312 and a rear end 314. As shown, the front end of the speaker 320 is inserted in the rear end of an interior cavity 340 defined by the speaker enclosure 330, and slides into the cavity 340 generally in a forward direction 360 so that the enclosure 330 covers the speaker 320. FIG. 3B illustrates the combination 310 of the speaker 320 fully enclosed by the speaker enclosure 330, following sliding of the speaker 320 completely into the cavity 340 in the forward direction 360.

Returning to FIG. 3A, the example jacket 330 includes forward and rear planar structures 350, 352 which each extend across the bottom of the jacket 330. As the speaker is inserted into the cavity 340 in the forward direction 360 as shown and comes into contact with a spring member 358 supported by and extending from the rear planar structure 352. The spring member 358 of the illustrated embodiment is formed from a thin sheet of metal extending off of the planar structure 352, although plastic or another resilient material can be used in other cases. The spring member 358 deflects away from the speaker 320 upon contact with the underside of the speaker 320. Once the speaker 320 is nearly fully inserted in the cavity 340, the spring 358 returns to its original un-deflected position. In particular, a first notch 356 is formed on the underside of the rear end the speaker 320. The spring member 358 extends generally parallel to the underside of the speaker 320, but is bent to include a protruding portion 359 that enters the first notch 356 when the spring member 358 returns to its original un-deflected position. When the spring member 358 is in the un-deflected position, a forward surface of the protruding portion 359 is parallel with and interacts with a forward-most sidewall 357 defined by the first notch 356 to resist movement of the speaker 320 with respect to the jacket 330 in the rearward direction 362. In addition, once the speaker 320 is fully inserted in the jacket 330, a rear-most side wall defined by a second notch 354 formed on the underside of the speaker 320 contacts a rear-most surface of a protuberance (not visible) formed on the interior side of the forward structure 350 of the jacket 330, thereby preventing further movement of the speaker 320 in the forward direction 360. A user can remove the speaker 320 by pulling the spring member 358 away from the bottom of the speaker 320, thereby lifting the spring member 358 out of the first notch 356, and sliding the speaker 320 with respect to the jacket 330 in the rearward direction 362. In this manner, the spring 358 and the protuberance provided on the rear planar structure 350 form portions of an attachment interface of the jacket 330, while the first and second notches 356, 354 form a corresponding attachment interface of the speaker 320. Thus, the attachment interface of FIG. 3A allows for latched, releasable attachment of the jacket 330 to the speaker 320 via single-direction sliding. The attachment interface shown in FIG. 3A is just one example. A wide variety of other types of attachment interfaces are possible. In addition, the male and female components can be reversed. For instance, one or more of the notches can be provided on the jacket 330 instead of the speaker 210, and one or more of the protuberances can be provided on the speaker 320 instead of the jacket 330.

In some embodiments, the enclosure 330 includes two parts. As is illustrated in FIG. 3B, a bottom component or part 360 of the enclosure 330 is configured for being attached to the combination 310 of the enclosure 330 and the speaker 320 so that the speaker 320 is fully enclosed. The bottom part 360 can be attached by any suitable means, such as by screws as is illustrated in FIG. 3B. The bottom part 360 can include a plate 350, which can be removable. In some embodiments, as is explained below, the plate 350 can be shaped for mounting or attaching the enclosed speaker combination 310 to one or more accessories. In some embodiments, any other suitable means for attaching the combination 310 to one or more accessories can be used. The combination 310 can be the same as the combination 150 illustrated in FIG. 1.

When the speaker 320 is enclosed in the enclosure 330, a connection can be established between the speaker and the enclosure as explained above. For instance, the speaker 320 and the enclosure 330 can include corresponding communication interfaces such as those described with respect to FIGS. 2A-2B. One-way or two-way commination can take place over the connection. The connection can be established in any suitable way, such as by one or more contacts of the speaker 320 being placed into electrical contact with one or more contacts of the enclosure 330 when the speaker 320 is enclosed by the enclosure. For instance, while not shown in FIG. 3A, one or more electrical contacts or leads can be provided on the jacket 330 and the speaker 320 to establish electrical connection between the two. For instance, electrical contacts can be provided on an underside of the top of the jacket 330, which contact corresponding contacts provided on the top side of the speaker 320 when the speaker 320 is fully inserted in the jacket 330.

FIG. 3B illustrates an example of a combination 310 of a speaker 320 and enclosure 330 where the enclosure 330 includes an output interface 340 having a display screen 342 configured to display a clock 344. Data for the output interface, such as clock type (e.g., analog or digital), time, and the like, can be communicated by the speaker 320 over the connection. The display 342 may also act as an input interface, allowing the user to control the clock and/or other functions of the speaker 320 and/or jacket 330. Alternative or additional elements can be displayed (or otherwise communicated) on the output interface.

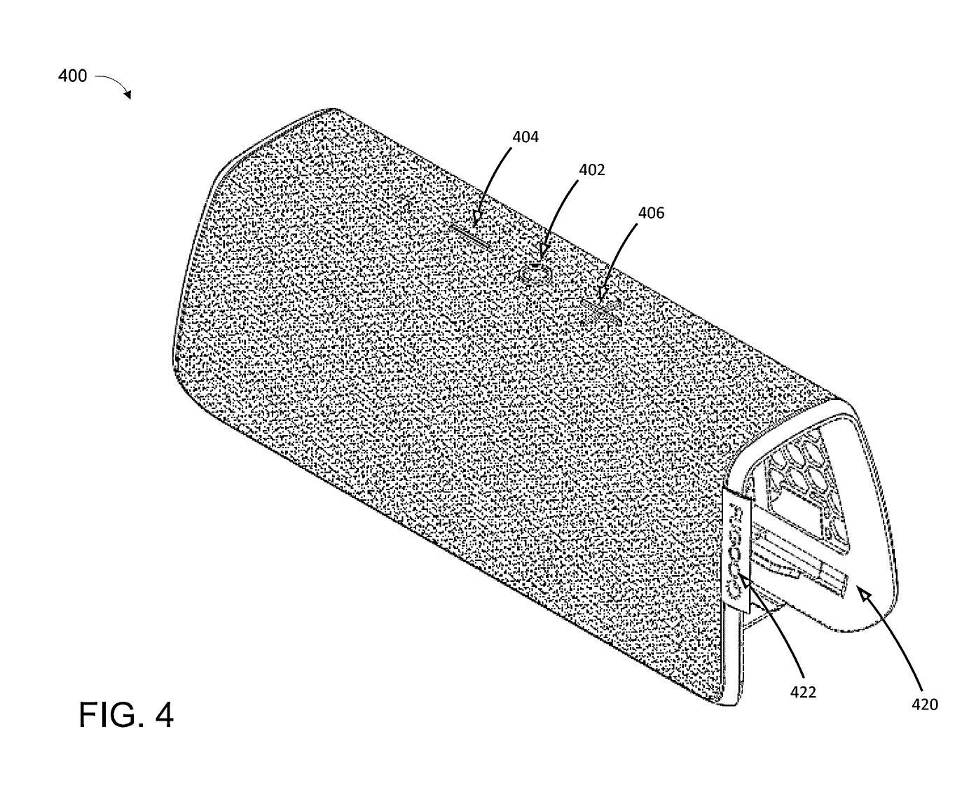

FIG. 4 illustrates a perspective view of a speaker enclosure or jacket 400 according to some embodiments. The jacket 400 can be the same as the jacket 330. The jacket 400 can be removably attached to the enclosure or housing of a speaker, such as the housing 110 of the speaker 1100 (illustrated in FIG. 11A). The jacket 400 can be attached to the housing 110 in the manner described with respect to FIGS. 3A-3B, or in other embodiments by any suitable attachment means, such as tabs, buttons, screws, fasteners, and the like. The jacket 400 includes controls 404 and 406 for controlling the volume up down and up, respectively, and control 402 for powering the speaker on/off. The controls 402, 404, and 406 can be buttons that are configured to interact with controls 144 positioned on the speaker housing 110 (illustrated in FIG. 11A). For example, the listener can operate controls 144 via pressing the controls 402, 404, and 406. The controls 402, 404, and 406 can interact with one or more controls 144 of the speaker 1100. In some embodiments, the jacket 400 can include additional controls, one or more controls can be omitted, one or more controls can be positioned on a different surface from the illustrated embodiment or in different position of the same surface.

The jacket 400 includes a housing 420 configured to enclose or partially enclose the speaker. The housing 420 can be configured to substantially match or correspond to the dimensions and shape of the speaker. The housing 420 includes exterior surface that defines an interior volume that is configured to enclose the speaker. The jacket 400 also includes a tag 422. The tag 422 can be configured as a “feature” tag that indicates certain capabilities of the jacket 420, such as audio acoustic capabilities, input capabilities, output capabilities, and the like. A speaker can select and implement a corresponding enclosure profile corresponding to the feature tag 422. For instance, a memory device of the jacket (such as flash memory module, ROM memory module, or any other suitable memory module) can store the capabilities of the jacket 420. In certain variations, the jacket 400 can be configured for indoor use. For example, the jacket 400 can be partly made of cloth material. In some embodiments, the jacket 400 can be configured for outdoor use.

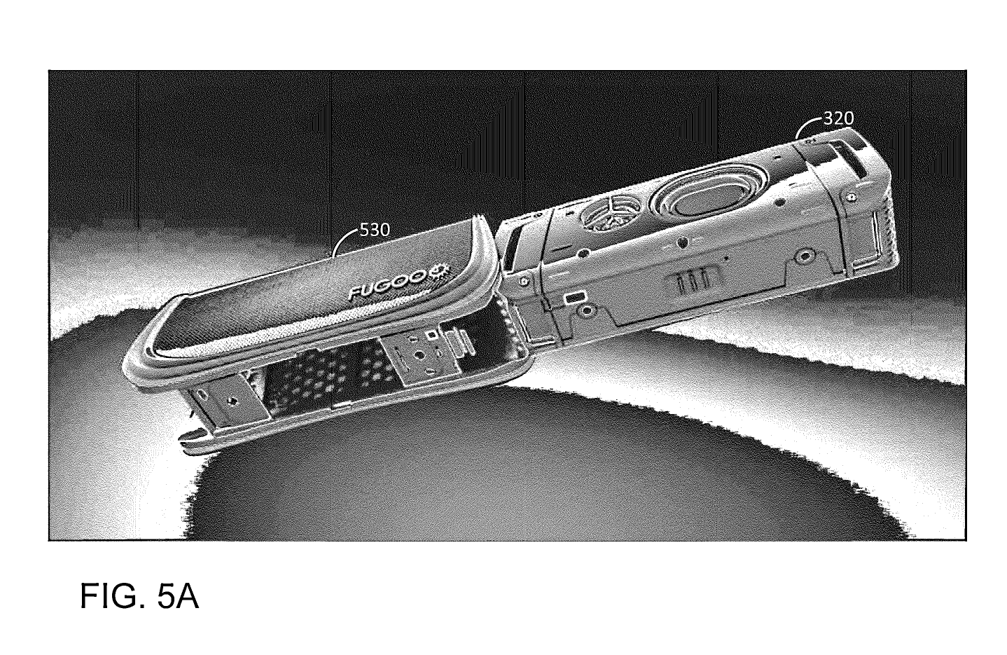

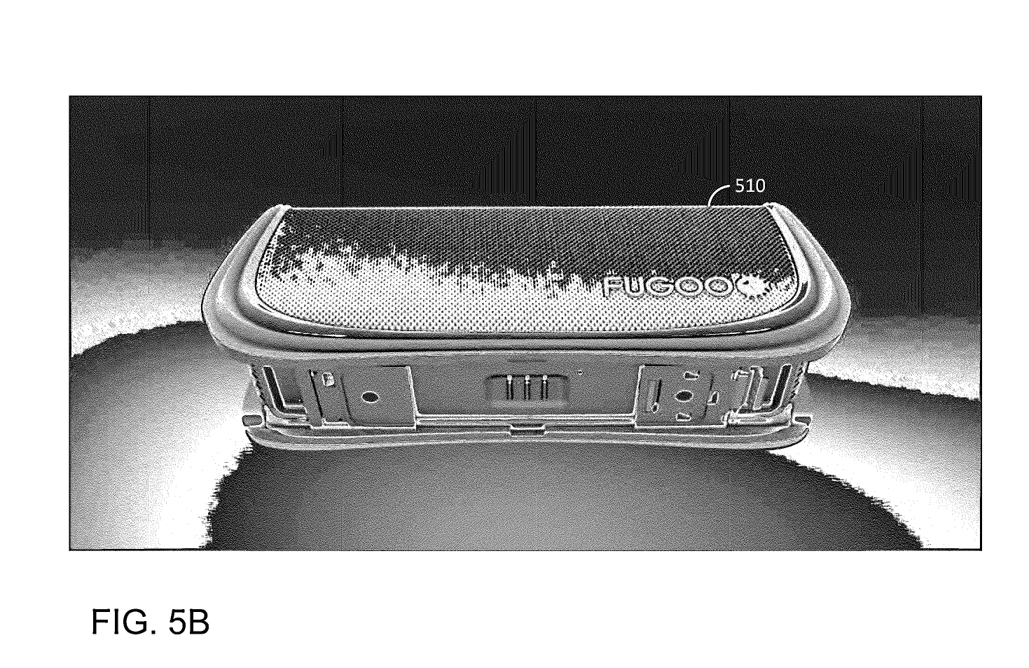

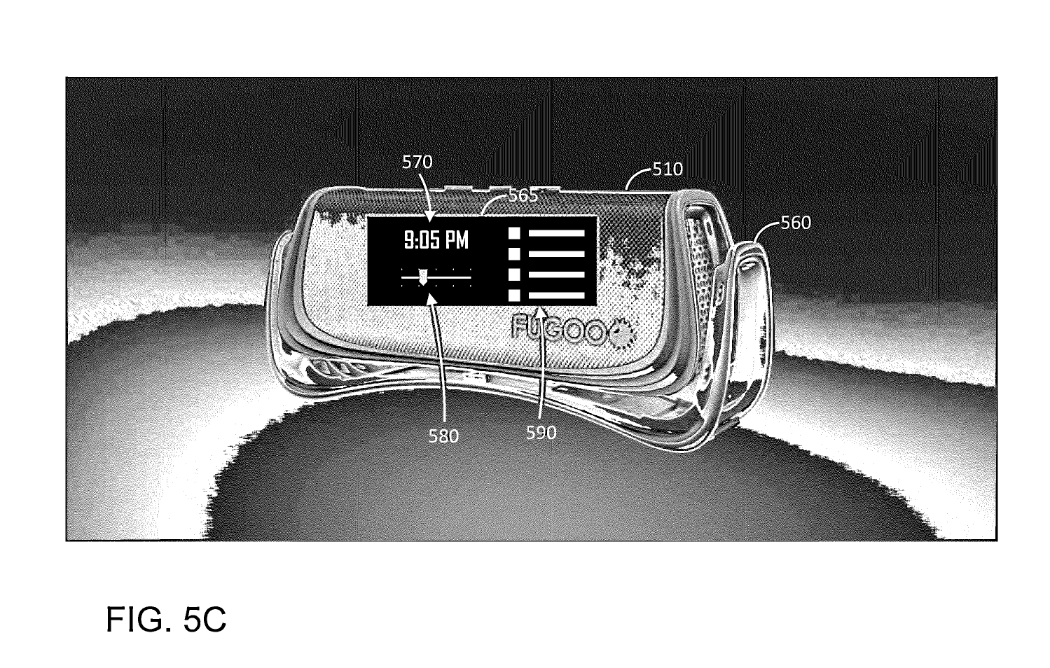

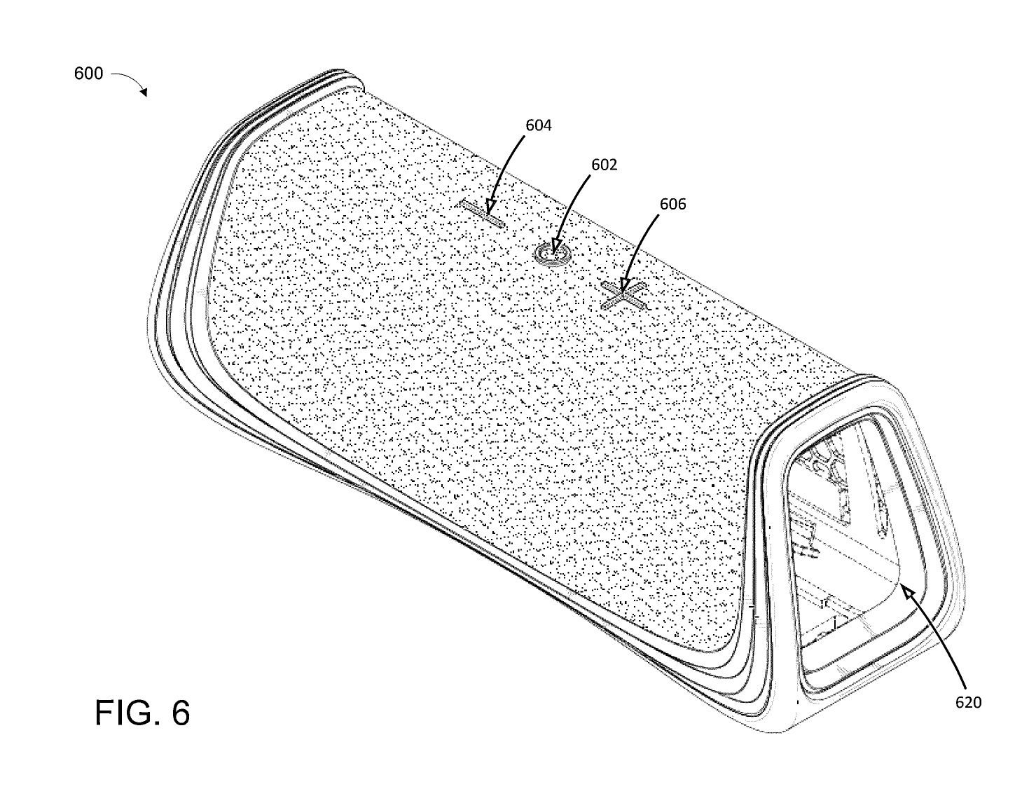

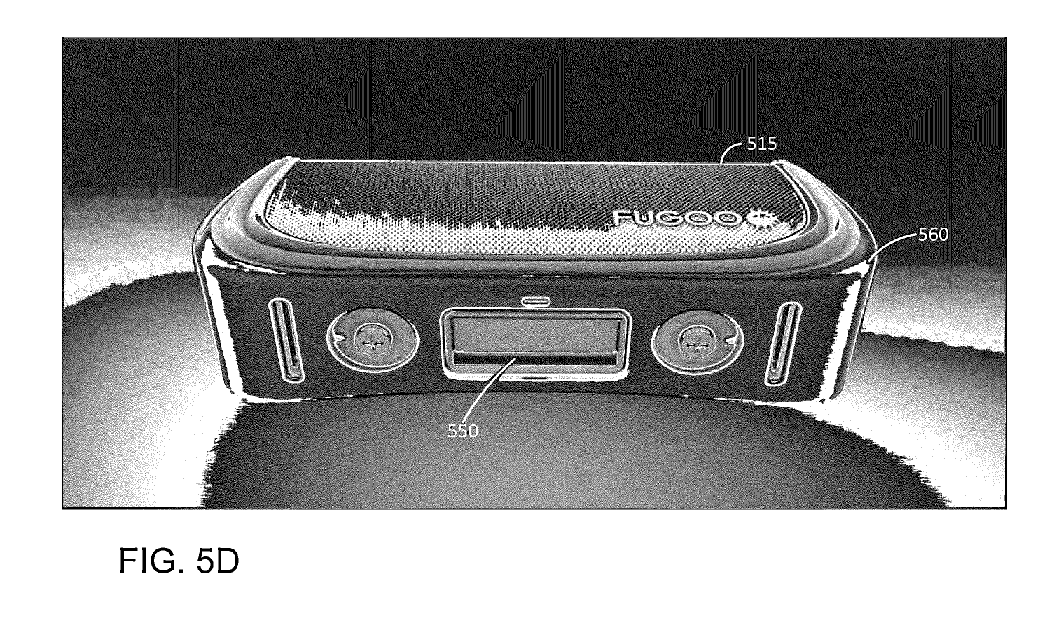

FIG. 5A illustrates placement of a speaker 520 in a speaker jacket or enclosure 530 according to some embodiments. As is illustrated, the speaker 520 (which can be same as the speaker 320) is positioned inside (for example, slid into) the speaker enclosure 530 so that the enclosure covers the speaker. The speaker 520 and enclosure 530 can include attachment interfaces that are similar to those of the speaker 320 and enclosure 330 described with respect to FIGS. 3A-3B, for example. FIG. 5B illustrates the combination 510 of the speaker 520 substantially fully enclosed by the speaker enclosure 530. In some embodiments, the enclosure 530 includes two parts. As is illustrated in FIG. 5C, an outer part or shell 560 of the enclosure is configured for being attached to the combination 510 of the enclosure 530 and the speaker 520 so that the speaker is substantially fully enclosed. The two-part construction of the enclosure 530 can assist to keep water, fluid, and particles from contacting the speaker 510. FIG. 5D illustrates a bottom perspective view of a fully enclosed speaker/enclosure combination 515, in which the enclosure 530 has been fully assembled (for example, the shell 560 attached to the enclosure).

The shell 560 can include a plate 550, which can be shaped for mounting or attaching the enclosed speaker combination 510 to one or more accessories. The plate can be removable. In some embodiments, any other suitable means for attaching the combination 510 to one or more accessories can be used. The combination 515 can be the same as the combination 160 illustrated in FIG. 1.

When the speaker 520 is enclosed in the enclosure 530, a connection can be established between the speaker and the enclosure as explained above. One-way or two-way commination can take place over the connection. As is illustrated in FIG. 5C, the enclosure 530 can include an output interface including a display 565 that displays a clock 570, control 580 (such as volume control, equalizer control, etc.), and playlist 590. Data for the output interface, such as clock type (e.g., analog or digital), time, song names for the playlist, and the like, can be communicated by the speaker 520 over the connection. The display 565 can also act as an input interface allowing users to enter commands and the like. The input interface can supplement or replace buttons provided on the speaker 510, or some other existing control interface of the speaker 510. The enclosure 530 can communicate user selections, such as song selection, volume settings, equalizer settings, and the like, to the speaker 520 over the connection. Alternative or additional elements can be displayed (or otherwise communicated) on the output interface. The connection can be established in any suitable way, such as by one or more contacts of the speaker 520 being placed into electrical contact with one or more contacts of the enclosure 530 when the speaker is enclosed by the enclosure.

FIG. 6 illustrates a perspective view of the enclosure or jacket 600 according to some embodiments. The jacket 600 can be the same as the jacket 530. The jacket 600 can be removably attached to the enclosure or housing of the speaker, such as the housing 110 of the speaker 1100 (illustrated in FIG. 11A). The jacket 600 can be attached to the housing 110 by any suitable attachment means, such as tabs, buttons, screws, fasteners, and the like. The jacket 600 includes controls 604 and 606 for controlling the volume up down and up, respectively, and control 606 for powering the speaker on/off. The controls 602, 604, and 606 can be buttons that are configured to interact with controls 144 positioned on the speaker housing 110 (illustrated in FIG. 11A). For example, the listener can operate controls 144 via pressing the controls 602, 604, and 606. The controls 602, 604, and 606 can interact with one or more controls 144 of the speaker 1100. In some embodiments, the jacket 600 can include additional controls, one or more controls can be omitted, one or more controls can be positioned on a different surface from the illustrated embodiment or in different position of the same surface.

The jacket 600 includes a housing 620 configured to enclose or partially enclose the speaker. The housing 620 can be configured to substantially match or correspond to the dimensions and shape of the speaker. The housing 620 includes exterior surface that defines an interior volume configured to enclose the speaker. The jacket 600 can also include a tag (not shown), which can be similar or substantially similar to the tag 422 of the jacket 400. In certain variations, the jacket 600 can be configured for outdoor use. For example, the jacket 600 can be fully or partly made of waterproof material and have one or more holes or grooves for draining water. In some embodiments, the jacket 600 can be configured for indoor use.

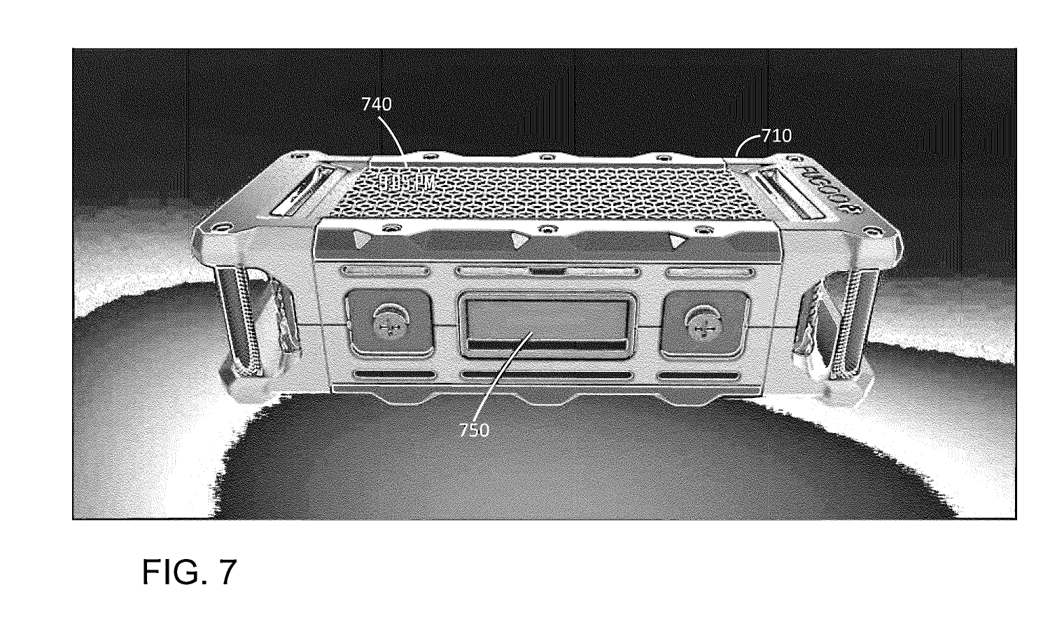

FIG. 7 illustrates a combination 710 of a jacket or enclosure fully enclosing a speaker (such as a speaker 320). In some embodiments, the enclosure 530 includes two parts. The fully assembled enclosure can include a plate 750, which can be shaped for mounting or attaching the enclosed speaker combination 710 to one or more accessories. The plate can be removable. In some embodiments, any other suitable means for attaching the combination 710 to one or more accessories can be used. The combination 710 can be the same as the combination 170 illustrated in FIG. 1.

When the speaker is enclosed as is illustrated in FIG. 7, a connection can be established between the speaker and the enclosure as explained above. One-way or two-way commination can take place over the connection. Data for the output interface, such as clock type (e.g., analog or digital), time, and the like, can be communicated by the speaker over the connection. Alternative or additional elements can be displayed (or otherwise communicated) on a display or other output interface (not shown). The connection can be established in any suitable way, such as by one or more contacts of the speaker being placed into electrical contact with one or more contacts of the enclosure when the speaker is enclosed by the enclosure.

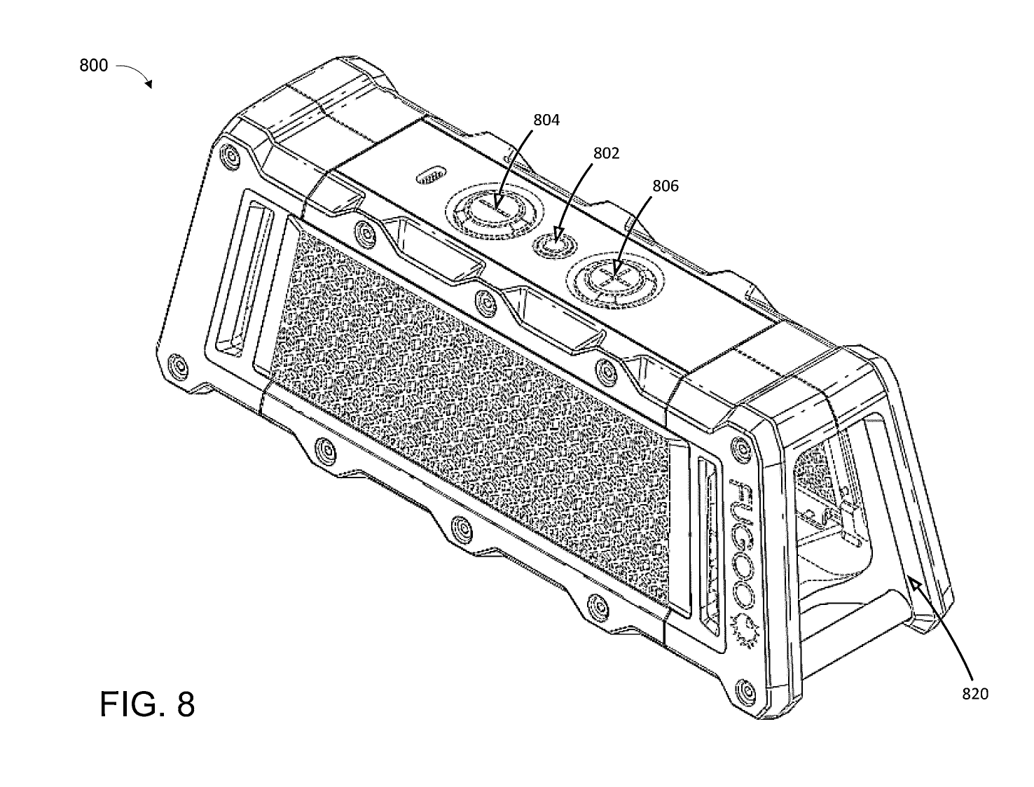

FIG. 8 illustrates a perspective view of an enclosure or jacket 800 according to some embodiments. The jacket 800 can be the same as the jacket illustrated in FIG. 7. The jacket 800 can be removably attached to the enclosure or housing of the speaker, such as the housing 110 of the speaker 1100 (illustrated in FIG. 11A). The jacket 800 can be attached to the housing 110 by any suitable attachment means, such as tabs, buttons, screws, fasteners, and the like. The jacket 800 includes controls 804 and 806 for controlling the volume up down and up, respectively, and control 802 for powering the speaker on/off. The controls 802, 804, and 806 can be buttons that are configured to interact with controls 144 positioned on the speaker housing 110 (illustrated in FIG. 11A). For example, the listener can operate controls 144 via pressing the controls 802, 804, and 806. The controls 802, 804, and 806 can interact with one or more controls 144 of the speaker 1100. In some embodiments, the jacket 800 can include additional controls, one or more controls can be omitted, one or more controls can be positioned on a different surface from the illustrated embodiment or in different position of the same surface.

The jacket 800 includes a housing 820 configured to enclose or partially enclose the speaker. The housing 820 can be configured to substantially match or correspond to the dimensions and shape of the speaker. The housing 820 includes exterior surface that defines an interior volume configured to enclose the speaker. The jacket 800 can also include a tag (not shown), which can be similar or substantially similar to the tag 422 of the jacket 400. In certain variations, the jacket 800 can be configured for outdoor use. For example, the jacket 800 can have a rugged construction and be made of rugged materials, such as think plastic or metal alloy. In some embodiments, the jacket 800 can be configured for indoor use.

FIG. 9 illustrates a perspective view of an enclosure or jacket 900 according to some embodiments. The jacket 900 can be removably attached to the enclosure or housing of the speaker, such as the housing 110 of the speaker 1100 (illustrated in FIG. 11A). The jacket 900 can be attached to the housing 110 by any suitable attachment means, such as tabs, buttons, screws, fasteners, and the like. As is illustrated in FIG. 9, the jacket 900 includes a housing that has an exterior surface and an interior volume for enclosing the speaker. A fastener 910 is positioned on the exterior surface, and the fastener 910 configured to maintain placement of a speaker within the jacket 900. The fastener 910 can be configured to move between open and closed positions. The jacket 900 includes a tag 922, which can be similar or substantially similar to the tag 422 of the jacket 400.

In some embodiments, the fastener 910 can be configured as a user or listener actuatable control for adjusting one or more properties of the audio playback. For example, the fastener 910 can be configured to adjust the playback volume. Moving the fastener from open to closed position can increase the volume (or vice versa). The jacket 900 can be configured so that manipulation of one or more properties of the jacket can cause adjustment of one or more parameters of audio playback. The jacket 900 can include additional fasteners, zippers, buttons, and the like. In some embodiments, the jacket 900 has similar or substantially similar functionality as one of the jackets 400, 600, and 800 described above.

In some embodiments, one or more jackets, such as jackets 400, 600, and 800, can be of any suitable shape to substantially match the shape of a speaker. The jackets can be made of any suitable material or combination of materials. The jackets can include additional controls or can omit one or more of the described controls. The controls can be placed on different surfaces of the jacket and in different places on a surface.

### Speaker Attachments

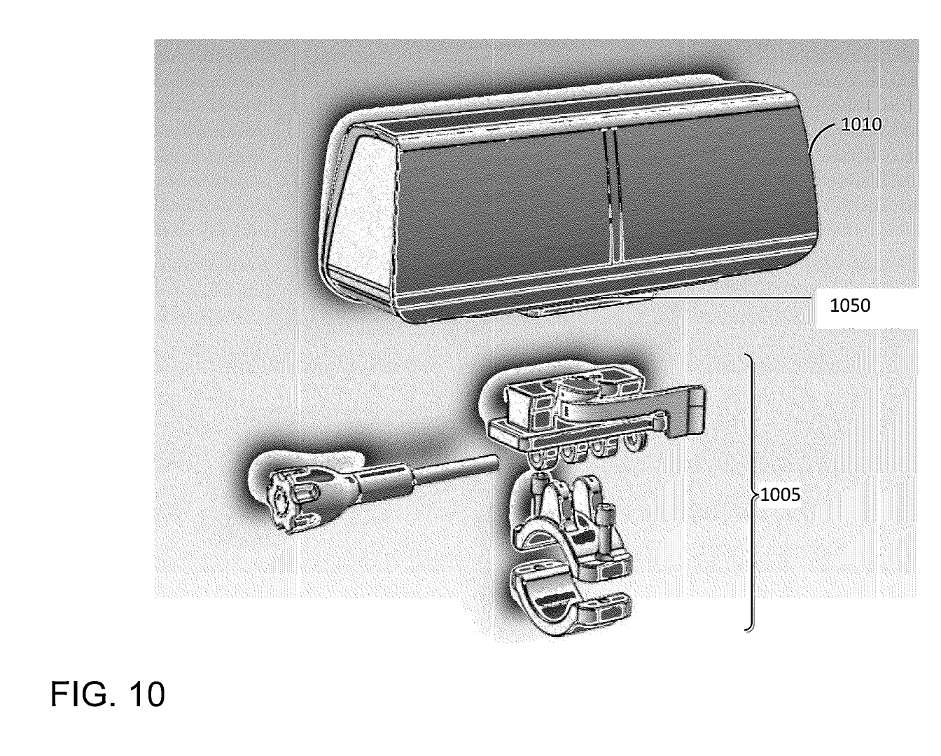

FIG. 10 illustrates attachment of a speaker enclosure to an accessory according to some embodiments. A combination 1010 of speaker enclosed in a jacket (such as jacket 400, 600, or 800) includes a plate 1050 for attachment or mounting the combination to one or more accessories, such as a mounting system 1005. The mounting system 1005 can be mounted to any suitable structure, such as rail, pole, bar, and the like. For example, the illustrated mounting system 1005 can be configured to be mounted to handle bars of a bicycle, scooter, motorcycle, etc.

In some embodiments, the jacket and/or speaker can communicate with the one or more accessories to which the combination 1010 is attached. A connection can be established in any suitable way with the accessory to which the combination 1010 is attached. For example, the connection can be established via the plate 1050 contacting the mounting system 1005. Data communicated over the connection can cause the accessory to which the jacket is mounted, the jacket, and/or the speaker to change one or more properties. For example, the accessory can change its lighting property when the combination 1010 is attached to it. As another example, one or more audio playback properties of the speaker (such as volume) can be changed in response to being attached to the accessory.

### Speakers

FIG. 11A illustrates a perspective view of a speaker 1100 according to certain embodiments. The speaker 1100 includes an enclosure or housing 110, having a front face or side 111. The speaker 1100 also has a rear face or side, bottom side, top side 115, right side or end 116 (also illustrated in FIG. 11B), and left side or end 117. The right 116 and left 117 sides are covered by end caps 132 and 134. The end caps 132 and 134 can be removable. The illustrated speaker 1100 is shaped as a generally elongate box having a trapezoidal cross-section. This form factor can resist tip over when the speaker 1100 is placed on surfaces, providing improved stability. The trapezoidal form factor also accommodates the natural shape of the hand when gripped from the top (narrower side of trapezoid in palm), providing enhanced ergonomics as compared to some other form factors (e.g., purely rectangular form factors). In other embodiments, speakers of any suitable shapes fall within the scope of the disclosure, such as rectangular box, square box, cylindrical, spherical, conical, toroidal, pyramidal, and the like.

A speaker driver 120 is enclosed in or otherwise supported by the housing 110 and, as shown, is facing out on the front side 111. In some embodiments, the speaker driver 120 can be a tweeter configured to reproduce high frequency audio, such as, audio in the range of about 2 kHz to about 20 kHz (e.g., between about 6-20 kHz, 7-20 kHz, 8-20 kHz, 9-20 kHz, 10-20 kHz, and the like). The speaker driver 120 can be configured to reproduce high fidelity audio. In some embodiments, the speaker driver 120 can be a full-range speaker, mid-range speaker, low frequency speaker, etc. The speaker driver 120 is an active driver in the illustrated embodiment. In some embodiments, the speaker driver 120 is not used.

In the illustrated embodiment, the speaker driver 120 is a tweeter having a diameter D of about 1.1 inches (approximately 28 mm). In various embodiments, the diameter D of the speaker driver 120 is at least about 0.5 inches, at least about 0.75 inches, or at least about 1 inch. In some embodiments, the diameter of the speaker driver 120 can be smaller than 0.5 inches or greater than about 1.1 inches. The depth of the speaker driver 120 can be selected to correspond to the depth of the speaker system 100. For example, the depth of the speaker driver 120 can be less than about 1.7 inches. As another example, the depth of the speaker driver 120 can be less than about 4 inches.

Another speaker driver can be enclosed in or otherwise supported by the housing 110 and can be facing out on the rear side (not shown). The additional speaker driver can be placed symmetrically or substantially symmetrically with respect to the speaker driver 120. The additional speaker driver can have same or substantially same features as the speaker driver 120. In some embodiments, the additional speaker driver is not used.

A speaker driver 122 is enclosed in or otherwise supported by the housing 110 and, as shown, is facing out on the front side 111. In some embodiments, the speaker driver 122 can be a low frequency speaker configured to reproduce low frequency audio or bass, such as, audio in the range of about 20 Hz to about 200 Hz. The speaker driver 122 can be passive. For instance, a passive speaker driver 122 is used, such as, a passive radiator speaker which may or may not include an active driver. In certain embodiments, a different passive driver 122 (e.g., a driver that does not include an actively driven component) is used, such as sealed or ported enclosure, a bass reflex system with one or more ports or vents, one or more reflex ports, and the like. The speaker driver 122 can be configured to reproduce high fidelity audio. In some embodiments, the speaker driver 122 can be a full-range speaker, mid-range speaker, tweeter, etc. In some embodiments, the speaker driver 122 is not used. In some other embodiments, the speaker driver 122 is an actively driven component.

In the illustrated embodiment, the speaker driver 122 is a passive radiator for generating relatively low frequency output and having a length L′ of about 2.1 inches (approximately 54 mm) and a height H′ of about 1.7 inches (approximately 43 mm). In various embodiments, the speaker driver 122 can have a length L′ of greater than about 1.0 inches, greater than about 1.5 inches, or greater than about 1.75 inches long, and a height H′ of greater than about 0.75 inches, greater than about 1.0 inches, or greater than about 1.5 inches. In some embodiments, the length L′ of the speaker driver 122 can be smaller than about 1.0 inches or greater than about 2.1 inches and the height H′ can be smaller than about 0.75 inches or greater than about 1.7 inches. In certain embodiments, for example, the speaker driver 122 can be about 4.0 inches long (approximately 101.2 mm) and about 2.4 inches high (approximately 61.2 mm). The depth of the speaker driver 122 can be selected to correspond to the depth of the speaker system 100. For example, the depth of the speaker driver 122 can be less than about 1.7 inches. As another example, the depth of the speaker driver 122 can be less than about 4 inches.

Another speaker driver can be enclosed in or otherwise supported by the housing 110 and can be facing out on the rear side (not shown). The additional speaker driver can be placed symmetrically or substantially symmetrically with respect to the speaker driver 122. The additional speaker driver can have same or substantially same features as the speaker driver 122. In some embodiments, the additional speaker driver is not used.

In some embodiments, the housing 110 includes one or more input devices 142, such as a microphone, and one or more user controls 144. The controls 144 can be power on/off, volume up/down, and the like. In some embodiments, additional or different controls and input devices can be used and can be placed on different surfaces of the housing 110 or in different places on the surfaces. In some embodiments, input devices or controls are not used.

The speaker 1100 can be portable. In some embodiments, the length L of the speaker 1100 can be about 6.5 inches (approximately 165.2 mm). The depth or width W of the speaker 1100 can be about 1.7 inches (approximately 43.5 mm), and the height H of the speaker 1100 can be about 2.3 inches (about 58.8 mm). In certain embodiments, the speaker 1100 is less than about 12 inches long, less than about 4 inches wide, and less than about 5 inches tall. In some embodiments, the speaker 1100 can be longer or shorter than about 6.5 inches, wider or thinner than about 1.7 inches, and taller or shorter than about 2.3 inches. For example, the speaker 1100 can be about 11.2 inches long (approximately 284 mm), about 3.4 inches wide (approximately 85.7 mm), and about 3.9 inches tall (about 98.6 mm). In certain embodiments, the speaker 1100 is less than about 24 inches long, less than about 8 inches wide, and less than about 10 inches tall.

While maintaining portability, the speaker 1100 can also generate audio output having a desired fidelity and loudness in part by being large enough to support a speaker driver architecture capable of providing such fidelity and loudness. For instance, the speaker 1100 can be large enough to support an arrangement of speaker drivers such as is shown and described with respect to FIGS. 1A-1E or with respect to any of the other embodiments provided herein. Moreover, the speaker 1100 can be large enough such that the housing 110 defines an interior cavity having a sufficient volume to provide a desired acoustic affect. Along these lines, certain embodiments of the speaker 1100 including any of those in the preceding paragraph are at least about 1 inch wide, at least about 4 inches long, and at least about 1.5 inches tall. In further embodiments, including any of those in the preceding paragraph, the speaker 1100 is at least about 0.75 inches wide, at least about 3.5 inches long, and at least about 1.0 inch tall. In yet additional embodiments, again including any of those in the preceding paragraph, the speaker 1100 is at least about 1.5 inches wide, at least about 5 inches long, and at least about 2 inches tall.

FIG. 11B illustrates another perspective view of the speaker 1100 with the side cap 132 removed exposing the right side 116 and the side cap 134 removed exposing the left side 117. The speaker driver 124 is enclosed in or otherwise supported by the housing 110 and, as shown, is facing out on the right side 116. In some embodiments including the illustrated embodiment, the speaker driver 124 can be a primary speaker configured to reproduce full-range audio, such as, audio in the range of about 20 Hz to about 20 kHz. The speaker driver 124 can be configured to reproduce high fidelity audio. In other embodiments, the speaker driver 124 is a mid-range speaker configured to reproduce middle frequencies, such as, audio in the range of about 300 Hz to about 5 kHz. In yet further embodiments, the speaker driver 124 can be a tweeter or low frequency speaker, etc. The illustrated speaker driver 124 is an actively driven component, although a passive component can be used in other embodiments. In some embodiments, one or more passive components (e.g., low frequency passive components are provided on the ends in addition to the speaker driver 124. In some embodiments, the speaker driver 124 is not used.

In the illustrated embodiment, the speaker driver 124 is a full range driver or woofer having a diameter D′ of about 1.5 inches (approximately 39 mm). In various embodiments, the diameter D′ of the speaker driver 124 can be at least about 0.5 inches, at least about 0.75 inches, or at least about 1.0 inch. In some embodiments, the diameter D′ of speaker driver 124 can be smaller than 0.5 inches or greater than about 1.5 inches. In certain embodiments, for example, the diameter D′ of the speaker driver 124 can be about 2.4 inches (approximately 60 mm). The depth of the speaker driver 124 can be selected to correspond to the depth of the speaker system 100. For example, the depth of the speaker driver 124 (and 125) can be less than about 1.7 inches. As another example, the depth of the speaker driver 124 (and 125) can be less than about 4 inches.

Another speaker driver can be enclosed or otherwise supported by the housing 110 and can be facing out on the left side 117 (not shown). The additional speaker driver can be placed symmetrically or substantially symmetrically with respect to the speaker driver 124. The additional speaker driver can have same or substantially same features as the speaker driver 124. In some embodiments, the additional speaker driver is not used.

In some embodiments, the speaker 1100 includes one or more electronic modules, such as one or more processors, microprocessors, controllers, microcontrollers, digital signal processors (DSP), and the like. The one or more electronic modules can be configured to receive audio from an audio source and provide high fidelity playback of the audio. In certain embodiments, the one or more electronic modules can process the received audio in order to attain or assist high fidelity playback. For example, the speaker 1100 can be configured to implement non-linear equalization techniques that amplify or boost lower frequency (or bass) audio components at lower sound intensity levels (e.g., lower volume settings). As the sound intensity level is increased, the amplification of bass components can be reduced. Non-linear equalization can enhance the quality of sound playback by boosting bass components without loss of output sound intensity. The speaker 1100 can include one or more memory modules.

In some embodiments, additional speaker drivers can be used or one or more speaker drivers can be omitted. For example, in certain embodiments, two tweeters can be positioned on each of the front and rear faces of the speaker 1100. A low frequency speaker can be positioned between the tweeter pairs arranged on each of the faces. In certain embodiments, one or more speaker drivers can be placed differently from the placement illustrated in FIGS. 11A-11B. For example, one or more speaker drivers can be placed on different surfaces of the housing or in different places on the surfaces. As another example, one or more speaker drivers can be positioned fully inside the housing. In some embodiments, the speaker 1100 is air tight or substantially air tight and waterproof or substantially waterproof.

FIG. 12 illustrates a speaker 1200 according to some embodiments. The speaker 1200 is in some respects similar to the speaker 1100. The speaker 1200 includes drivers 1220 and 1221, which (like the speaker driver 120) can be tweeters configured to reproduce high frequency audio, such as, audio in the range of about 2 kHz to about 20 kHz (e.g., between about 6-20 kHz, 7-20 kHz, 8-20 kHz, 9-20 kHz, 10-20 kHz, and the like). Speaker drivers 1220 and 1221 can be configured to reproduce high fidelity audio. In some embodiments, speaker drivers 1220 and 1221 can be a full-range speakers, mid-range speakers, low frequency speakers, etc. Speaker drivers 1220 and 1221 are active drivers in the illustrated embodiment. In some embodiments, one or both speaker drivers 1220 and 1221 are not used.

The speaker 1200 includes a speaker driver 1222, which (like the speaker driver 122) can be a low frequency speaker configured to reproduce low frequency audio or bass, such as, audio in the range of about 20 Hz to about 200 Hz. The speaker driver 1222 can be passive. For instance, a passive speaker driver 1222 is used, such as, a passive radiator speaker which may or may not include an active driver. In certain embodiments, a different passive driver 1222 (e.g., a driver that does not include an actively driven component) is used, such as sealed or ported enclosure, a bass reflex system with one or more ports or vents, one or more reflex ports, and the like. The speaker driver 1222 can be configured to reproduce high fidelity audio. In some embodiments, the speaker driver 1222 can be a full-range speaker, mid-range speaker, tweeter, etc. In some embodiments, the speaker driver 1222 is not used. In some other embodiments, the speaker driver 1222 is an actively driven component.

In some embodiments, the speaker 1200 includes one or more input devices, such as a microphone, and/or user controls 1244. The controls 1244 can be power on/off, volume up/down, equalizer, and the like. In some embodiments, additional or different controls and input devices can be used and can be placed on different surfaces of a housing of the speaker 1200 in different places on the surfaces. In some embodiments, input devices or controls are not used.

Additional speaker drivers can be enclosed in or otherwise supported by a housing of the speaker 1200 and can be facing out on the rear side (not shown). The additional speaker driver can be placed symmetrically or substantially symmetrically with respect to the speaker drivers 1220, 1221, and 1222. The additional speaker driver can have same or substantially same features as the speaker driver 1220, 1221, and 1222 respectively. In some embodiments, one or more of the additional speaker drivers are not used.

### Other Variations

Additional embodiments of the disclosed speakers and speaker enclosures are described in the following patent applications: U.S. Patent Application No. 61/923,575, titled “PORTABLE STEREO SOUND SYSTEM”, filed Jan. 3, 2014 (Atty. Docket No. FUG00.009PR), and U.S. Patent Application No. 61/923,554, titled “SPEAKER SYSTEM” (Atty. Docket No. FUG00.010PR). Each of these patent applications is incorporated by reference in its entirety.

### TERMINOLOGY

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Conjunctions, such as “and,” “or” are used interchangeably and are intended to encompass any one element, combination, or entirety of elements to which the conjunction refers.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described herein. Various disclosed and illustrated modules may be implemented as software and/or firmware on a logic circuitry, processor, ASIC/FPGA, or dedicated hardware. Various disclosed and illustrated modules can include logic circuitry. Software and other modules may reside on servers, workstations, personal computers, computerized tablets, PDAs, and other devices suitable for the purposes described herein. Software and other modules may be accessible via local memory, via a network, via a browser, or via other means suitable for the purposes described herein. User interface components described herein may comprise buttons, knobs, switches, touchscreen interfaces, and other suitable interfaces.

Further, the processing of the various components of the illustrated systems can be distributed across multiple logic circuits, processors, machines, networks, and other computing resources. In addition, two or more components of a system can be combined into fewer components. Various components of the illustrated systems can be implemented in one or more virtual machines, rather than in dedicated computer hardware systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. The actual steps taken in the disclosed processes may differ from those disclosed or illustrated. Depending on the embodiment, certain of the steps described above may be removed, others may be added. In addition, each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flow chart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flow chart and/or block diagram block or blocks.

While certain embodiments have been described, these embodiments have been presented by way of example only, and are not intended to limit the scope of the disclosure. Indeed, the novel methods and systems described herein may be embodied in a variety of other forms; furthermore, various omissions, substitutions and changes in the form of the described methods and systems may be made without departing from the spirit of the disclosure. The accompanying claims and their equivalents are intended to cover such forms or modifications as would fall within the scope and spirit of the disclosure.

What is claimed is:

1. A portable speaker system comprising:
a portable speaker comprising:
a portable housing;
one or more loudspeakers supported by the portable housing;
an audio processor within the portable housing and configured to process a source audio signal to generate a processed audio signal;
audio electronics within the portable housing configured to receive the processed audio signal and to drive the loudspeakers to output audio based on the processed audio signal; and
a rechargeable battery; and
a first speaker enclosure configured to releasably retain the speaker, the first speaker enclosure comprising:
a first housing comprising an exterior surface and an interior volume, the interior volume dimensioned to receive the speaker; and
a first communication interface configured to communicate data to the speaker, the data including first information that enables the speaker to identify an audio output profile associated with the first enclosure,
wherein the audio processor is further configured, based at least in part on the first information, to process the source audio signal in accordance with a first audio output profile associated with the first enclosure.

2. The system of claim 1, wherein the speaker is compatible with a second speaker enclosure configured to releasably retain the speaker, the second speaker enclosure comprising:
a second housing comprising an exterior surface and an interior volume, the interior volume dimensioned to receive the speaker; and
a second communication interface configured to communicate data to the speaker, the data including second information that enables the speaker to identify an audio output profile associated with the second enclosure,
wherein the processor is further configured, based at least in part on the second information, process the source audio signal in accordance with a second audio output profile associated with the second enclosure, the second audio output profile different from the first audio output profile.

3. The system of claim 1, wherein the first enclosure further comprises an input interface on the exterior surface of the first housing, the input interface configured to receive user input data, wherein the user input data is communicated to the speaker via the first communication interface, causing adjustment of one or more audio playback parameters by the speaker.

4. The system of claim 3, wherein the input data comprises volume adjustment information.

5. The system of claim 1, wherein the first enclosure further comprises one or more light sources configured to illuminate the first housing.

6. The system of claim 1, wherein the first enclosure further comprises an electronic display on the exterior surface of the first housing.

7. The system of claim 6, wherein the electronic display is updated based on information electronically received by the first speaker enclosure from the speaker when the speaker is releasably retained within the first enclosure.

8. The system of claim 7, wherein the electronic display is configured to display a clock.

9. The system of claim 7, wherein the electronic display is configured to display one or more of artist, song title, or playlist information.

10. The system of claim 1, wherein the first speaker enclosure further comprises a memory device configured to store the first information.

11. The system of claim 1, wherein the first audio output profile causes the audio processor to process the source audio signal in accordance with acoustic properties of the first enclosure.

12. The system of claim 11, wherein the acoustic properties of the first enclosure are related to one or more of physical dimensions of the enclosure and composition of materials of the first housing.

13. The system of claim 1, wherein the first audio output profile comprises one or more audio signal processing settings.

14. A portable speaker system comprising:
a portable speaker comprising:
a portable housing;
one or more loudspeakers supported by the housing;
an audio processor configured to process a source audio signal to generate a processed audio signal; and
a rechargeable battery; and
a speaker enclosure configured to releasably retain the speaker, the speaker enclosure comprising:
a body comprising an exterior surface and an interior volume, the interior volume dimensioned to receive the speaker;
a communication interface configured to allow electronic communication between the speaker and the speaker enclosure; and
a display configured to display graphical information based on data received via the communication interface.

15. The portable speaker system of claim 14 wherein graphical information includes time information.

16. The portable speaker system of claim 14 wherein graphical information includes one or more audio controls.

17. A method of reproducing audio using a portable speaker, the method comprising:
communicating an enclosure profile to a speaker enclosed in a speaker enclosure, thereby causing the speaker to:
based at least in part on the enclosure profile, select a corresponding audio output profile from a plurality of audio output profiles, and
output audio in accordance with the selected audio output profile,
wherein the method is performed by the speaker enclosure.

18. The method of claim 17, further comprising: receiving input data entered via an interface provided on the speaker enclosure and configured to change at least one audio output parameter of the speaker; and communicating the input data from the enclosure to the speaker, thereby causing the speaker to change the at least one audio output parameter.

19. The method of claim 17, further comprising outputting, via an interface provided on the enclosure, data provided to the enclosure from the speaker, wherein the data is output in addition to audio produced by the speaker.
